(19) United States
(12) Patent Application Publication
(10) Pub. No.: US 2013/0116044 A1
(43) Pub. Date: May 9, 2013

(54) NETWORK MULTI-PLAYER TRIVIA-BASED GAME AND CONTEST

(71) Applicant: Lawrence Schwartz, Dallas, TX (US)

(72) Inventor: Lawrence Schwartz, Dallas, TX (US)

(21) Appl. No.: 13/667,822

(22) Filed: Nov. 2, 2012

Related U.S. Application Data
(60) Provisional application No. 61/555,178, filed on Nov. 3, 2011.
(60) Provisional application No. 61/718,546, filed on Oct. 25, 2012.

(51) Int. Cl. A63F 13/12

(52) U.S. Cl. CPC A63F 13/12
USPC 463/29

(57) ABSTRACT

The present disclosure relates to computer-implemented methods, computer-readable media, and computer systems for providing a location-aware, trivia-based, massively-multiplayer online game and contest. One computer-implemented method includes authenticating a user for access to an asynchronous, turn-based, massively-multiplayer online game (MMOG) with user account log-in information received from a client computing apparatus following direction to the MMOG from a MMOG source, determining that the MMOG source is classified as premier, transmitting premium content associated with the MMOG source to the client computing apparatus, prompting to purchase a premium user experience, receiving an indication to purchase the premium user experience, and transitioning to a mini-store to permit purchase of the premium user experience.

This Application claims priority under 35 U.S.C. §119(e) to U.S. Provisional Patent Application Ser. No. 61/555,178, filed on Nov. 3, 2011, and U.S. Provisional Patent Application Ser. No. 61/718,546, filed on Oct. 25, 2012. The entire contents of U.S. Provisional Patent Application Ser. No. 61/555,178 and U.S. Provisional Patent Application Ser. No. 61/718,546 are hereby incorporated by reference.

### BACKGROUND

A massively-multiplayer online game (MMOG) is an online multiplayer video game typically played on a combination of private networks coupled to the Internet. In the MMOG, a large number of players are supported simultaneously and the MMOG usually features at least one persistent virtual world. MMOG gameplay may be both synchronous and asynchronous and the MMOG system/virtual world may preserve a player's settings, score, status, etc. regardless of whether the player is logged on to the MMOG. MMOGs enable players to interact, compete, and cooperate on a large scale, either locally or around the world. MMOGs are typically played on a combination of private networks coupled to the Internet. While MMOGs may be played on personal computers, an increasing number of mobile game consoles, mobile devices, smartphones, and/or other suitable computing devices can access the Internet and can run MMOGs regardless of a player's location and activities.

The popularity of multiplayer games may trace back to Dungeons & Dragons™ or even tabletop war games. “Dungeons & Dragons” is a registered trademark of Wizards of the Coast. The beginning of massively multiplayer online role playing games may be traced back to the multi-user dungeon (MUD) internet games, which were text-based multiplayer games typically using a command line interface. However, with the rising acceptance and technical capabilities of personal computers, as well as increased graphical and processing capabilities of mobile game consoles, mobile devices, and smartphones, massively multiplayer online games have become wildly popular around the world. In fact, part of the draw of massively multiplayer online games is that players from any continent can typically be online and interacting at any given time. The player is considered online when the player is logged into the game server through a game client. Conversely, a player is considered offline when the player is not logged into the game server through a game client.

Players of MMOGs tend to invest a great deal of time in increasing their status in relation to other players within a MMOG. As such, MMOG players are often a captive audience that is of interest to advertisers. MMOG advertisements may take many forms, such as pop-ups, in-game product-placements, and banner ads. MMOG generated advertising revenue may be used for investment, dividends, prizes for players, and network enhancement, for example.

Also of interest to MMOG providers and advertisers are location-based technologies. Many mobile devices provide persistent location-based awareness to applications running on the mobile device and allow MMOG providers and advertisers to customize the MMOG experience and displayed advertisements, respectively, based upon the player's geographic location and whether a player enters and/or remains within a specific geographic location for a predetermined amount of time.

Crucial to MMOG system health, efficiency, cost-effectiveness, revenue generation, and enjoyable play are various technologies providing dynamic themed content and a themed user interface, convergence of mobile applications and television/live “game shows,” system log aggregation (including monitoring and analytics), metrics gathering (including monitoring and analytics), continuous system monitoring, messaging (internal and external), push notifications, and/or asynchronous, stateful question management. These various technologies enhance the enjoyability, efficiency, usability, and profitability of the MMOG system as well as lowering the MMOG system's total cost of ownership.

### SUMMARY

The present disclosure relates to computer-implemented methods, computer-readable media, and computer systems for providing a location-aware, trivia-based, massively-multiplayer online game and contest. One computer-implemented method includes authenticating a user for access to an asynchronous, turn-based, massively-multiplayer online game (MMOG) with user account log-in information received from a client computing apparatus following direction to the MMOG from a MMOG source, determining that the MMOG source is classified as premier, transmitting premium content associated with the MMOG source to the client computing apparatus, prompting to purchase a premium user experience, receiving an indication to purchase the premium user experience, and transitioning to a mini-store to permit purchase of the premium user experience.

Other implementations of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features:

In a first aspect, combinable with the general implementation, wherein the MMOG source is at least one of a demographic value, a date, a time, a location, an organization, a political event, a sporting event, a hyperlink, or a social media posting.

In a second aspect, combinable with any of the previous aspects, wherein a premium user experience is presented on the client computing apparatus using the transmitted premium content.

In a third aspect, combinable with any of the previous aspects, wherein the premium user experience includes at least one of enhanced gameplay, additional gameplay functionality, additional premium content, or themes.

A fourth aspect, combinable with any of the previous aspects, further comprising playing a determined number of free games with the premium user experience.

A fifth aspect, combinable with any of the previous aspects, further comprising determining that an indication was received to purchase the premium user experience.

A sixth aspect, combinable with any of the previous aspects, further comprising transmitting non-premium content to the client computing apparatus, presenting a non-premium user experience using the transmitted non-premium content, and playing a determined number of free games with the non-premium user experience.

The subject matter described in this specification can be implemented in particular implementations so as to realize one or more of the following advantages. First, the massively-multiplayer online game (MMOG) system will handle virtually unlimited ongoing games between players. Second, a premium solution will allow for making new content available to players without a requirement to update a client application. This enhances marketability of content to both content producers and consumers. Third, the MMOG system infrastructure permits the relatively simple addition of additional client application platforms (e.g., ANDROID, WINDOWS PHONE, etc.) to the MMOG system. Other advantages will be apparent to those skilled in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example massively-multiplayer online game (MMOG) system in accordance with some implementations of the present disclosure.

FIG. 2 is a block diagram illustrating an alternative MMOG system in accordance with some implementations of the present disclosure.

FIG. 3 is a block diagram illustrating components of an example MMOG system client in accordance with some implementations of the present disclosure.

FIG. 4 is a block diagram of an example MMOG platform in accordance with some implementations of the present disclosure.

FIG. 5 is a block diagram illustrating an alternative MMOG system in accordance with some implementations of the present disclosure.

FIG. 6 is a block diagram illustrating an example framework for providing system log aggregation (including monitoring and analytics), metrics gathering (including monitoring and analytics), and/or continuous system monitoring in a MMOG system in accordance with some implementations of the present disclosure.

FIG. 7 is a block diagram illustrating functionality extensions to an example game node in a MMOG system in accordance with some implementations of the present disclosure.

FIG. 8 is a flow chart for selecting a premium membership and providing dynamic themed content and a themed user interface in a MMOG system in accordance with some implementations of the present disclosure.

FIG. 9 is a flow chart for selecting premium content in a MMOG system in accordance with some implementations of the present disclosure.

### DETAILED DESCRIPTION

The present disclosure relates to computer-implemented methods, computer-readable media, and computer systems for providing a location-aware, trivia-based massively-multiplayer online game (MMOG) and contest.

To illustrate these concepts, the disclosure illustrates an example game system 100 for executing, evaluating, and otherwise processing user actions in a gaming platform where users compete against one another by answering trivia questions in a location-based game.

A MMOG typically allows players to choose a representative character, or “avatar,” to represent themselves in the MMOG virtual world. It will be understood that “player”, “character”, “user”, and “avatar” may be used interchangeably in certain circumstances as appropriate. A player-chosen avatar may be textual, an image, a combination of text and image, or other suitable representative indicator for a player.

For the purposes of this disclosure, “real time” generally means that a user selection and resulting action in the MMOG are temporally proximate (e.g., five-hundred milliseconds, one second, five seconds) such that the events appear as simultaneous or appear as substantially simultaneous to a player. For example, in a real-time game, a player may answer a received trivia question and receive a response within five seconds from the example game system 100. To the player this five-second proximate response would appear real-time and without substantial delay.

In some implementations, the game system 100 can execute one or more of the following: present information associated with players (e.g., an avatar) in a graphical user interface (GUI) environment; present trivia questions in the GUI; present trivia-related and non-trivia-related mini-games in the GUI; receive information identifying player-selected answers to trivia-based questions and mini-games, and to player-selected advertisements; display announcements to the player; present unique codes (e.g., barcodes, QR codes or an alphanumeric sequence) to be used for redemption purposes for prizes; and chat functionality between players, advertisers, and/or MMOG providers. In some implementations, game system 100 can implement trivia games and games of skill on mobile devices in arenas and in other venues. In some implementations, game system 100 can serve proprietary or licensed content for use in trivia games on mobile devices. In some implementations, game system 100 can implement a periodic MMO game that can played simultaneously via a mobile device, website, or TV with or without prizes on a periodic timeframe. For example, the periodic timeframe may be daily, weekly, monthly, annually, or other suitable periodic timeframe. While the following example description is centered on trivia games, the game system 100 can cover other topics associated with online games, such as military games, sports games, social games and/or other games.

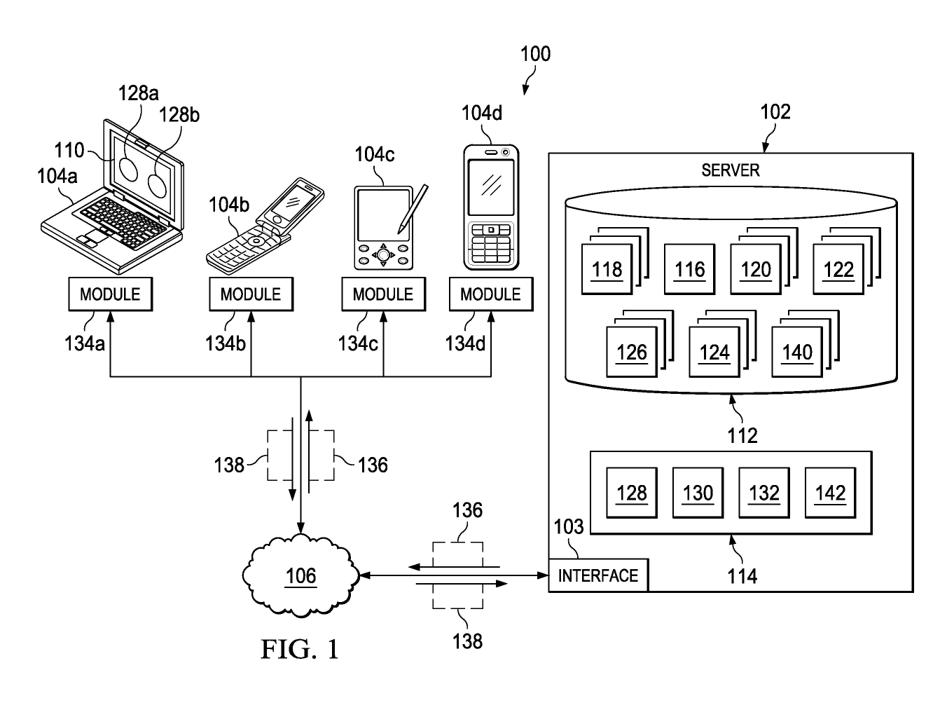

Turning now to FIG. 1, FIG. 1 is a block diagram illustrating an example MMOG system 100 in accordance with some implementations of the present disclosure. The game system 100 includes a server 102 and clients 104a-d communicably coupled through a network 106. In this implementation, each client 104 includes a GUI 110 for displaying information associated with an MMOG and an associated trivia-based game system. The server 102 includes an interface 103, memory 112 and processor 114.

The interface 103 is used by the server 102 to communicate with other systems in a client-server or other distributed environment (including within game system 100) connected to the network 106 (e.g., an associated client 104, as well as other systems communicably coupled to the network 106). FIG. 1 depicts a client-server environment, but could also represent a cloud-computing network. Various other implementations of the illustrated game system 100 can be provided to allow for increased flexibility in the underlying system, including multiple servers 102. In those implementations, the different servers 102 can communicate with each other via a cloud-based network or through the connections provided by network 106. Returning to the illustrated game system 100, the interface 103 generally comprises logic encoded in software and/or hardware in a suitable combination and operable to communicate with the network 106. More specifically, the interface 103 may comprise software supporting at least one communication protocol associated with communications such that the network 106 or the interface's hardware is operable to communicate physical signals within and outside of the illustrated game system 100.

Further, the memory 112 locally stores a game application 116 that manages a trivia-based MMOG, user files 118 that identify information associated with a user (e.g., character, trivia questions, status), graphics rules 120 that identify directives used to present graphics elements in the GUI 110, navigation module 122 that manages tasks and navigation in the virtual world, trivia question rules 124 that identify directives for evaluating competition between players, and chat rules 126 for identifying directives for dialogue between players, advertisers, and/or MMOG providers. The processor 114 includes a presentation engine 128 for presenting graphical elements 128a and 128b through the GUI 110, based, at least in part, on the graphics rules 120, competition engine 130 for evaluating user actions during competition, a chat engine 132 for managing dialogue between users based, at least in part, on the chat rules 126, and an advertising engine 142 for managing based, at least in part, on advertisement rules 140. While the illustrated implementation includes the different modules in the server 102, a subset of these modules can reside in the client 104 without departing from the scope of this disclosure. For example, the client 104 may include the presentation engine 128 and the graphics rules 120. In some implementations, instead of storing information associated with the user in user files 118, user information may be stored in, for example, a database (not illustrated). The database may be part of memory 112 or local/remote to server 102.

As mentioned above, the game system 100 includes, invokes, executes, references, or is communicably coupled with the server 102. The server 102 can include any software, hardware, and/or firmware configured to process gaming actions using the game application 116. For example, the server 102 may be a computing device that executes actions for multiple users such as, for example, trivia questions answered in a plurality of different trivia games. In this example, the server 102 may support hundreds or thousands of users simultaneously. Typically, the server 102 can continuously process many thousands of selected actions and/or communicate with different user devices (e.g., clients 104). FIG. 1 provides merely one example of clients that may be used with the disclosure. Each client is generally intended to encompass any suitable processing device. For example, although FIG. 1 illustrates one server 102 that may be used with the disclosure, game system 100 can be implemented using computers other than servers, as well as a server pool. Indeed, server 102 may be any computer or processing device such as, for example, a blade server, general-purpose personal computer (PC), web server, WINDOWS Server, UNIX-based computer, handheld device or smartphone, or any other suitable device. In other words, the present disclosure contemplates computers other than general purpose computers, as well as computers without conventional operating systems. Server 102 may be adapted to execute any operating system including LINUX, UNIX, WINDOWS Server, or any other suitable operating system. Servers may also be physical and/or virtual.

In the illustrated implementation, the server 102 can execute the game application 116 at any appropriate time such as, for example, in response to requests or inputs from the clients 104 or any appropriate computer system coupled with network 106. The game application 116 is any suitable application software running on the server 102 that manages a trivia-based MMOG in a graphical environment. In some examples, the game application 116 may manage a persistent world, such as a virtual world, that continues to exist even after a user exits the world and/or that user-made changes to the environment state may be permanent. The game application 116 may support a plurality of users (e.g., thousands) submitting a plurality of actions (e.g., millions of actions per day). This example game application 116 may execute one or more of the following: receive and process login and logout requests, receive information identifying answers to trivia questions and chat submissions from a plurality of users; present the virtual world through the GUI 110 in accordance with the location information; implement and manage at least one location-based game; receive selections from users that change aspects of the character and/or virtual world; update the virtual world for users in accordance with the received changes; and/or other operations.

The user profiles 118 can include one or more entries or data structures that include or otherwise identify one or more aspects of a user. For example, the user profile 118 may identify a character, information associated with the appearance of that character, trivia questions, virtual items, a status, and/or other information associated with the avatar. In some implementations, the user profile 118 can include information identifying attributes of a character, information associated with a character's trivia questions and virtual items, and values of character parameters that may change over time. In regards to character attributes, the user profile 118 may include or identify a type of character, a character name, login and security information and settings, gender information, attributes and character data such a score, ranking, virtual items owned or otherwise associated with the character, physical aspects (e.g., height, weight, hair style, hair color, eye color), trivia games completed or currently underway, friend information, win and loss ratings for player games, badges earned and display preferences. As for character parameters, the user profile 118 may identify current values of character parameters that may vary with time. In some implementations, the user profile 118 can include a trivia game history, a win/loss count, and/or other information associated with the user.

The graphics rules 120 can include any parameters, variables, policies, algorithms, instructions, settings, and/or rules for presenting elements representing user information through the GUI 110. For example, in some implementations, the graphics rules 120 may define a layout and/or design characteristics (i.e., a “skin”) for displaying elements representing questions and messages on a client device. For example, questions may fade-in or fade-out on the display or be rendered unanswerable if not answered within a predetermined timeframe. In some implementations, the graphics rules 120 can define layout and/or design characteristics for presenting elements, as well as transformation rules for dynamically modifying the attributes of the elements (e.g., size, color, symbol, shape) based, at least in part, on one or more events. For example, the graphics rules 120 may define orientation rules, placement rules, color rules, scaling rules, image transformation rules (e.g., scaling rules, cropping rules), and/or other settings for presenting graphical elements representing user information. Of course, the above parameters and rules are for example purposes, and the graphics rules 120 may include some, none, or different rules for presenting user elements without departing from the scope of this disclosure. For example, the graphics rules 120 may identify a rule indicating an expression for updating a color of an element in response to an event such as a user answering a question.

In addition, the graphics rules 120 may include directives for cinematic aspects based, at least in part, on different stages and/or player actions. For example, the graphics rules 120 may identify different camera movements and cinematic approaches for each step or stage in a trivia game such as a pre-determined angle and distance from a displayed graphical element. For example, the camera may move along predetermined tracks, which, for a given stage, may include multiple random predetermined tracks for random selection. In addition, the random tracks may be different for different teams. In some implementations, the graphics rules 120 can identify directives for one or more of the following steps: starting, question receiving, question answering, conceding, winning, losing, and/or others.

The navigation module 122 can include software for assisting or otherwise aiding character movements through the virtual world and to determine the location of a user for location-based games. In some implementations, the virtual world can map to the real world and allow users to navigate to real-world geographic locations corresponding to locations/zones in the virtual world. In some implementations, the navigation module can monitor a characters position within an established geo-fenced area related to a trivia game. For example, if the virtual world is a sports stadium, the virtual world may be a virtual representation of the sports stadium and a geo-fence may be established by the server 102 that extends 100 yards from the perimeter of the physical sports stadium. In this example, if a player leaves the geo-fence area, they would automatically forfeit any progress in an established trivia game and would be required to start over from the beginning, if possible. In another example, the navigation module 122 may present directions to a destination associated with performing a task in a trivia game (e.g., go to an advertiser's booth to scan/enter a code for the next trivia question). In some implementations, the navigation module 122 can aide in the following: (1) trivia games the characters participate in; and (2) navigation between two points in the virtual world. For example, the navigation module 122 may present a list of tasks associated with a trivia game and a character's progress. As for navigation examples, the navigation module 122 may present user locations (e.g., point on maps) and directions to destinations selected by the user. The navigation module 122 may display a compass indicating directions the user should take to reach a destination. In some implementations, the navigation module 122 can include instructions for one or more of the following: presenting information associated with quests such as tasks and progress; locating characters on a map of the virtual world; determining a course between two places in the virtual world; presenting directions to a user based on a destination; and/or other aspects associated with navigating in the virtual world. In regards to locating a position on a map, the navigation module 122 may present a map of the virtual world and indicate a character's location by, for example, overlaying a graphical element (e.g., a dot, figure, etc.). The map may include structures, characters, quests, and/or other elements in the virtual world. As for navigating to a destination, the navigation module 122 may present a 2D/3D arrow through the GUI 110 indicating directions for a player. In some implementations, the 2D/3D arrow can be presented independent of the virtual world or without presenting the arrow in the virtual world. The 2D/3D element may rotate about a single axis. In some cases, the 2D/3D element may not be updated based on height differences between the player and the destination. In some implementations, the direction can be based on a current goal in a trivia game and using a navigation map. The navigation map may identify each zone and include a graph of nodes that connect different locations in the virtual world. In some implementations, the navigation module 122 can indicate directions to the closest goal in the event the trivia game includes a plurality of different goals. For example, the navigation module 122 may determine a path to each goal with the least amount of travel time based on one or more algorithms. In some examples, a simple A* path finding algorithm may be evaluated to find the shortest path from one node or place to another. In these examples, the paths may be chained together across zone boundaries if the destination lies outside the current zone. While illustrated in the server 102, the navigation module 122 or one or more processes in the navigation module 122 may be executed in the client 104, which means any information such as the zone names may be located within a map data file stored in the client 104. Each path generated may include a distance-traveled value for comparison to other paths. In connection with determining a path to a destination, the navigation module 122 may include instructions for changing the orientation of, for example, a compass presented to a user as the path changes. For example, the navigation module 122 may include instructions for presenting an arrow right when the determined path turns right. In these implementations, the navigation module 122 can include instructions for presenting turn-by-turn directions to a user in the virtual world using one or more graphical elements. In addition to a list of goals, the navigation module 122 may present a brief textual summary of each goal and the player's amount of progress towards completion of that goal (e.g., answer a trivia question based upon the Middle Ages (2 out of 5), visit a predefined location in the virtual/physical world and answer a trivia question presented at that location, etc.).

The competition rules 124 can include any parameters, variables, algorithms, instructions, rules, objects or other directives for evaluating actions between users during the trivia game, such as answering trivia questions in a trivia game speed-round. For example, the competition rules 124 may determine which user wins the trivia game based, at least in part, on the difficulty of the trivia questions asked and the speed the trivia questions were answered as opposed to simply the number of questions correctly answered. In some implementations, the competition rules 124 can implement mathematical and/or logical expressions for determining values for one or more parameters associated with a user or his character. For example, the competition rules 124 can facilitate determining a status value (e.g., ranking) based on one or more variables associated with, for example, the geographic location, the time and/or date, trivia games played, trivia games won and/or lost, and/or other aspects of competition.

In addition, the competition rules 124 may include instructions to present text to a user in response to one or more trivia game events. For example, the competition rules 124 may include a round announcement indicating a round in a trivia game. The format may be “Round X” and the text may appear in the middle of the screen in large, colorful, exciting letters. The competition rules 124 may include instructions to indicate a ranking gain. For example, when the player wins a round in the trivia game, the words “Rank Up!” may appear on the screen in nice, big, colorful letters. In some implementations, the competition rules 124 can include instructions to indicate end of a trivia game. For example, the words “Winner!” or “You Lost!” may appear. If the players win the trivia game, then the words “Winner!” may appear in large, colorful letters. If they lose, the words “You Lose!” may appear in large, sad letters.

The chat rules 126 can include any parameters, variables, algorithms, instructions, rules, objects or other directives for entering and presenting dialogue between players, advertisers, and/or MMOG providers through GUI 110. For example, the chat rules 126 may include instructions for filtering dialogue between players based on, for example, a difference in chat levels. In some implementations, the chat rules 126 can include directives for one or more of the following: determining levels of players participating in a dialogue; representing the chat levels of players in the 2D/3D environment, identifying rules for filtering dialogue based on player levels; modifying dialogue between players in accordance with the rules; displaying a user's chat level using, for example, an icon; and/or other rules. In some implementations, the chat rules 126 can include a list of pre-defined phrases that a user can select to present to another player. Additional phrases may be purchased, acquired through winning trivia games, or gifted by players, advertisers, and/or MMOG providers, and/or otherwise added to the list. In some implementations, the chat rules 126 can include directives associated with one or more of the following: restricting chat messages to a specific geographic area/zone, restricting chat messages to a specific date and/or time; sending chat messages to players on the same and/or different servers; providing a mechanism for players to subscribe and/or unsubscribe players; providing dialogue channels that are zone-wide only and other channels that cross all zones; and/or complying with the COPPA laws (see http://www.coppa.org/) such as logging and archiving dialogue. The chat rules 126 may include different permissions based on a user's status. For example, the chat rules 126 may include permissions such as an easy chat, a secure chat, an open chat, and/or others.

The chat rules 126 may identify directives for easy chat that present a plurality of selectable actions and/or phrases for a user. For example, the instructions may include a list that may be opened by clicking on an icon in the upper right hand corner of the GUI 110. In some implementations, the chat rules 126 can be instructions for presenting selected chat to players within a specified range (e.g., 30 meters). The range at which these bubbles are presented may be adjustable. In some cases, the chat rules 126 include instructions for switching between a chat bubble and a window in the GUI 110. The distance between when the chat bubble appears on top of a user's head, and the distance to when the dialogue appears on the side of the screen may vary between users. For example, the range at which chat bubbles appear above the head may start at 30 meters. If the speaker is out of view, the chat rules 126 may include instructions for presenting the dialogue on the side of the GUI 110 that is closest to the speaker, but kept within the boundaries of the player's screen such that the text is fully readable, and may be prefaced by the speaker's name. In some implementations, the chat rules 126 can prevent or remove presentation of a dialogue box when an off-screen speaker is outside a specified range (e.g., 20 meters). In addition, the chat rules 126 may identify a plurality of different chat boxes and directives for presenting dialogue in the different boxes based on one or more parameters. For example, the chat rules 126 may identify 10 predetermined slots that are each fixed in size. The parameters for presenting the dialogue in different boxes may include, for example, proximity, friend, chat level, player age, and/or others. In addition, the chat rules 126 may include instructions for presenting dialogue such as font, text, color, bubble tint, orientation and/or other aspects for presenting dialogue in a 2D/3D environment. For example, the chat rules 126 may include instructions for presenting dialogue in a white comic book style bubble with black text and for a 3D presentation rotating the dialogue to face each player. In some implementations, the chat rules 126 include instructions for scaling dialogue based, at least in part, on a distance between players. For example, the size of the chat bubble may scale down linearly to 20% at 30 meters and then disappear at greater distances. In some implementations, the chat rules 126 can specify a period of time for presenting dialogue. For example, chat bubbles and/or the accompanying off-screen chat boxes may stay on the screen for four seconds. In some implementations, the chat rules 126 can include instructions for deleting or at least modifying other graphical elements associated with the player presenting dialogue. For example, the presented dialogue may replace a name billboard when a player presents dialogue.

In addition, the chat rules 126 may include instructions based on different types of dialogue. For example, the chat rules 126 may identify a plurality of different selectable dialogue types and rules for presenting dialogue based on the selected type. The chat rules 126 may identify “Text” as a dialogue type and present the entered dialogue to a single player. In addition, the chat rules 126 may include instructions for presenting elements different from text such as, for example, socials and/or emotes. For example, emotes may include animations applied to a player's character and may include sound effects. In some implementations, the chat rules 126 can include instructions to automatically present an emote if a text option is selected. For example, an emote may be a social animation and/or an associated text phrase describing the action being performed, such as “Susan waves to you.” or “Timmy takes a bow.” Some emotes may not be associated with text. In some implementations, the chat rules 126 can include instructions to add actions to, for example, a character. For instance, the chat rules 126 may include instructions for adding facial expressions (e.g., increasing eye size, turning mouth to a smile) in response to, for example, a selected phrase. The chat rules 126 may include instructions for one or more of the following: eye animation; mouth animation; character animation; character animation; sound effect; and/or others.

In regards to open chat, the chat rules 126 may filter dialogue exchanged through open chat using, for example, dictionaries of acceptable words and unacceptable phrases. In some implementations, the chat rules 126 can include a white list that identifies acceptable words for use in filtered chat. In these cases, the chat rules 126 can include instructions for presenting words colored RED as they are being typed into the interface unless that word is identified in the white list. For example, the letters in the word belligerent may change colors during typing as described below: (1) “bel” (at this point, the letters are red); (2) “bell” (at this point, the letters are white because the word “bell” is valid); (3) “belli” (at this point, the letters turn red); and (4) belligerent . . . (at this point, the letters turn while white). In some implementations, the words in red can be replaced by a character string such as “#$%!” when this dialogue is displayed to other players of filtered chat or lower chat level. In some implementations, the chat rules 126 can include a Black List that identifies phrases that are prohibited and include instructions for presenting the letters in, for example, red. For example, the letters in the phrase “look under my robe” may change color during typing as follows: (1) Look (would be white); (2) Look under (would be white); (3) Look under my (would be white); and Look under my robe (at least the phrase “under my robe” would be red). The chat rules 126 may include instructions to compare entered text to one or more lists in response to a last user action (e.g., spacebar hit). In some implementations, the chat rules 126 may include directives associated with one or more of the following: predicting text to help with spelling issues; securing chat level based on a parent password; and/or other features. The chat rules 126 may include instructions to open a text entry box in response to a user action (e.g., pressing enter). The chat rules 126 may include instructions for presenting text based on the number of characters entered. For example, if the character number exceeds a character limit (e.g., 54), the chat rules 126 may include instructions to remove the text from the chat box and automatically display the text in a normal billboard style chat bubble. In addition, the chat rules 126 may include instructions for presenting text to nearby players, only to a single player (e.g., selected from the GUI 110 or from the Friends); and/or others. In some implementations, the chat rules 126 can include instructions for using different background colors and shapes for chat bubbles based on the type of communication. For example, the chat rules 126 may include instructions for chat bubbles as follows: Open Chat—different color background than Easy Chat; Easy Chat—different color background than Open Chat; Open Tell—Same color as Open Chat, different shaped chat bubble; and Easy Tell—Same color as Easy Chat, different shaped chat bubble. In some implementations, the chat rules 126 can prevent texts entered from a player using open chat from being presented to a player using easy chat. Though, the chat rules 126 may include instructions for indicating an attempt to communicate such as a sound effect and/or a nonsensical character string in the dialogue box. The chat rules 126 may include instructions for limiting access to open chat based on age, parental consent, and/or other factors.

The advertising rules 140 may identify directives, instructions, and rules for advertising that provide a plurality of selectable advertisements and advertising methods to present advertisements to a user. For example, the advertising directives may include instructions that a banner advertisement for a specific restaurant is to be displayed for all first-time players to a specific trivia game in a specific city.

Processor 114 executes instructions and manipulates data to perform operations of the server 102. Although FIG. 1 illustrates a single processor 114 in the server 102, multiple processors 114 may be used according to particular needs, and reference to processor 114 is meant to include multiple processors 114 where applicable. In the illustrated implementation, the processor 114 executes various software such as the illustrated presentation engine 128, competition engine 130, and chat engine 132 at any appropriate time such as, for example, in response to a request or input from a user of the client 104 or any appropriate computer system coupled with network 106. Indeed, the software may be written or described in any appropriate computer language including C, C++, Java, Visual Basic, assembler, Perl, any suitable version of graphics software or application programming interfaces (APIs), as well as others. It will be understood that the software may include any number of sub-modules, such as the illustrated engines and third party modules or libraries, or it may instead be a single multi-tasked module that implements the various features and functionality through various objects, methods, or other processes. Regardless of the particular implementation, “software” or “computer readable instructions” may include any software, firmware, wired or programmed hardware, or any combination thereof (embodied on or in tangible computer readable media) as appropriate to, when executed, instruct the respective one or more processors.

The presentation engine 128 can include any software operable to present data associated with a character. For example, the presentation engine 128 may present 2D/3D objects (e.g., floating 3D objects) that indicate one or more aspects of the character (e.g., rank, score, etc.) and dynamically update the presentation based, at least in part, on one or more aspects of, for example, a trivia game. In some implementations, the presentation engine 128 can execute one or more of the following: identify one or more attributes of a player in a user profile 118; generate a player avatar or character based, at least in part, on the identified attributes; receive a request from the user to view one or more graphical elements (e.g., items) from a user; identify one or more aspects of the requested element in the user profile 118; generate a presentation of the graphical element to display through the GUI 110; identify one or more characters in a trivia game and associated actions selected from the users; dynamically present and/or update presentation of graphical elements in response to user actions; identify graphics rules 120 associated with a player's context; present graphical elements to the user in accordance with the graphics rules; and/or other presentation process with players interacting in a virtual world.

The competition engine 130 can include any software operable to evaluate actions executed by players in a trivia game. For example, the competition engine 130 may determine how much a ranking is reduced due to a trivia game loss based, at least in part, on the difficulty of the trivia questions asked in the trivia game and/or other parameters. In some implementations, the competition engine 130 can execute one or more of the following: identify a player selection and associated character attributes based, at least in part, on the corresponding user profiles 118; group multiple players in teams in accordance with one or more user selections; identify competition rules 124 based, at least in part, on a format associated with the trivia game (e.g., player versus player, team versus team); identify the turns for each player in a trivia game; notify a player when their turn is identified; advance the turn to the next player when the previous player either selects an action or times out; identify questions selected by the users in the trivia games and associated aspects of the identified question (e.g., difficulty level, genre); the target of any selected question, if any; identify one or more equations associated with the played question using the competition rules 124; determine results of played questions based, at least in part, on the identified equations and variables associated with the trivia game; and/or update user profiles 118 in accordance with the determined results. Based on the format of the trivia game, the competition engine 130 may identify one or more competition rules 124 associated with the format. In some implementations, the trivia game can be between players and characters generated by the game application 116 such as virtual artificial intelligence players. During trivia games, the competition engine 130 can receive a selection from a user that identifies a question from a plurality of selectable questions and identify one or more expressions from the competition rules 124 associated with the question. As described above, the competition engine 130 may select an expression for determining an amount of damage (e.g., ranking reduction, score reduction) to a player resulting from a played question. In connection with solving identified expressions, the competition engine 130 may determine values for one or more parameters included in the identified expression. The competition engine 130 may determine values from user profiles 118, values from the virtual environment, and/or other aspects of the virtual world. In addition, the competition engine 130 may initiate an update of the virtual world such as presenting visual and/or sound effects, updating graphical elements associated with players, and/or other effects experienced by the user.

The chat engine 132 can include any software operable to manage dialogue between players. For example, the chat engine 132 may filter dialogue between players based, at least in part, on players' chat levels and/or dialogue content. In some implementations, the chat engine 132 can execute one or more of the following: receive requests to present dialogue to one or more users from the clients 104; identify one or more rules associated with the players using the chat rules 126; determine one or more parameters associated with the users (e.g., distance, chat level) using, for example, the user profiles 118; determine whether the text matches one or more lists (e.g., white list, black list) included in the chat rules 126; present the text to the users in accordance with the rules and the one or more parameters; dynamically update the text based, at least in part, on additional text entered by the users; and/or other processes. In some implementations, the chat engine 132 can receive a request identifying dialogue (e.g., selected, user entered) and a dialogue type such as player to player (e.g., whisper, secured chat). In connection with the request, the chat engine 132 may identify a chat level associated with the requesting player based, at least in part, on the user profile 118. For example, the chat engine 132 may determine a player has an open chat level or an easy chat level. In regards to filtered chat, the chat engine 132 may compare entered text to one or more lists of prohibited and/or acceptable text. In response to at least a match, the chat engine 132 may dynamically update the text in accordance with the rules such as replacing text with a string of characters or updating the color of the letters. In some implementations, the chat engine 132 can present the dialogue based on parameters associated with the environment. For example, the chat engine 132 may switch between presenting the dialogue in a bubble or chat box based on proximity of characters and/or display preferences of the player. In the case that the game application 116 presents multiple dialogue boxes, the chat engine 132 may switch the text between a plurality of different boxes based on, for example, length of text, time entered, and/or other parameters.

The advertising engine 142 can include any software operable to manage and display advertisements to players. For example, the advertisement engine 142 may not display a specific banner advertisement during a specific part of a trivia-game so as to not distract a player based, at least in part on the advertising rules 140. In some implementations, the advertising engine is geographically aware and will present advertisements depending on the geographic location of the player.

Clients 104a-d are any devices (e.g., computing devices) operable to connect or communicate with the server 102 or network 106 using any communication link. Each client 104 includes, executes, or otherwise presents a GUI 110 and comprises an electronic device operable to receive, transmit, process and store any appropriate data associated with game system 100. While the illustrated implementation includes example clients 104a-d, game system 100 can include any number of clients 104 communicably coupled to the server 102. Further, “client 104,” “user,” “player,” “avatar,” and “character” may be used interchangeably, as appropriate. Moreover, for ease of illustration, each client 104 is described in terms of being used by one user. But many users may use one device or one user may use multiple devices. Further, the illustrated clients 104 may be adapted to execute any physical or virtual operating system, including Unix, Linux, Windows, Mac OS, WebOS, iOS, Android, or any other suitable operating system.

As used in this disclosure, a client 104 user is any person, group, organization, a process implemented in software or hardware, or any other entity that may use or request others to use game system 100. Client 104 is intended to encompass a personal computer, touch screen terminal, workstation, network computer, kiosk, wireless data port, smart phone, personal data assistant (PDA), one or more processors within these or other devices, or any other suitable processing or electronic device used by a user viewing content from the server 102. For example, the client 104 may be a smart phone operable to wirelessly connect with an external or unsecured network. In another example, the client 104 can comprise a laptop that includes an input device, such as a keypad, touch screen, mouse, or other device that can accept information, and an output device that conveys information associated with questions and answers posted using the server 102, including digital data, visual information, or GUI 110. Both the input device and output device may include fixed or removable storage media such as a magnetic computer disk, CD-ROM, or other suitable media to both receive input from and provide output to users of clients 104 through the display, namely the client portion of GUI 110. In some implementations, client 104 can have a built-in or communicably coupled camera used to scan, input, or retrieve data pertaining to either a MMOG trivia game or advertising. For example, the client 104 may scan a QR code or a bar code to gain access to and initialize a trivia game in a specific geographic location.

The GUI 110 comprises a graphical user interface operable to allow the user of the client 104 to interface with at least a portion of game system 100 for any suitable purpose, such as viewing a virtual world in real time. Generally, the GUI 110 provides the particular user with an efficient and user-friendly presentation of data provided by or communicated within game system 100. The GUI 110 may comprise a plurality of customizable frames or views having interactive fields, pull-down lists, and buttons operated by the user. The GUI 110 can be configurable, supporting a combination of graphical elements, to present the Web pages 118 including the graphical elements 128a/b. The term graphical user interface may be used in the singular or in the plural to describe one or more graphical user interfaces and each of the displays of a particular graphical user interface. The GUI 110 may be any graphical user interface, such as a generic web browser or touch screen that processes information in the game system 100 and efficiently presents the results to the user. The server 102 can accept data from the client 104 via a client application or web browser (e.g., Microsoft Internet Explorer or Netscape Navigator) and return the appropriate HTML, XML, and/or other responses to the browser using the network 106, such as the graphical elements 128a and 128b (“graphical elements 128”).

The graphical elements 128 may include any graphical elements that present 2D/3D elements to the user of the client 104. For example, the graphical elements 128 may represent questions in connection with a user selecting a question to play. In some implementations, the graphical elements 128 can be interactive elements such that a selection executes one or more processes (e.g., answering a trivia question). The graphical elements 128 may include one or more of the following: text, color, sound, buttons, fields, and/or any other suitable electronic element. For example, the graphical elements 128 may be a radio buttons, each of which corresponds to an answer to a trivia question.

As previously mentioned, the client 104 may execute one or more processes illustrated as executed by server 102. In some implementations, the client 104 can include a client-side module 134 that processes information associated with the game application 116. For example, the server 102 may transmit message 136 to the client 104a via network 106 and client-side module 134a, and the client 104a may transmit message 138 via client-side module 134a and network 106 to the server 102. The server 102 may transmit a message 136 to the client-side module 134a indicating a trivia game has begun. In response to at least a user selecting one or more graphical elements 128, the client module 134a may transmit information identifying one or more answers selected by the user for a current round in the trivia game. The server 102 may transmit a message 136 to client module 134a indicating actions selected by other players in the trivia game. Using the included information, the client-side module 134a may resolve the winner of the trivia game based, at least in part, on the selected actions and present a 2D/3D sequence illustrating the results. In some implementations, the client-side module 134a can execute one or more processes associated with the competition engine 130, such as determining the results of a trivia game, and one or more process of the presentation engine 128 for presenting 2D/3D elements 128 illustrating the results of a trivia game. The server 102 may transmit messages to the client-side module 134a indicating one or more of the following: trivia game ended; a new trivia game is starting; a new player has joined the trivia game; player left the trivia game; a teammate's selected action and results; rank of players at the start of the trivia game; and/or other information.

Network 106 facilitates wireless or wireline communication between the server 102 and any other local or remote computer, such as clients 104. Network 106 may be all or a portion of an enterprise or secured network. While illustrated as single network, the network 106 may be a continuous network logically divided into various sub-nets or virtual networks, so long as at least portion of the network 106 may facilitate communications of answers and references between the server 102 and at least one client 104. In some implementations, the network 106 encompasses any internal or external network, networks, sub-network, or combination thereof operable to facilitate communications between various computing components in the game system 100. The network 106 may communicate, for example, Internet Protocol (IP) packets, Frame Relay frames, Asynchronous Transfer Mode (ATM) cells, voice, video, data, and other suitable information between network addresses. The network 106 may include one or more local area networks (LANs), radio access networks (RANs), metropolitan area networks (MANs), wide area networks (WANs), all or a portion of the global computer network known as the Internet, and/or any other communication system or systems at one or more locations.

While FIG. 1 illustrates a plurality of components, not all components illustrated within FIG. 1 may be utilized in each implementation of the present disclosure. Additionally, at least one component described herein may be located external to example game system 100, while in other implementations, certain components can be included within or as a portion of at least one described component, as well as other components not described. Further, certain components illustrated in FIG. 1 may be combined with other components, as well as used for alternative or additional purposes, in addition to those purposes described herein.

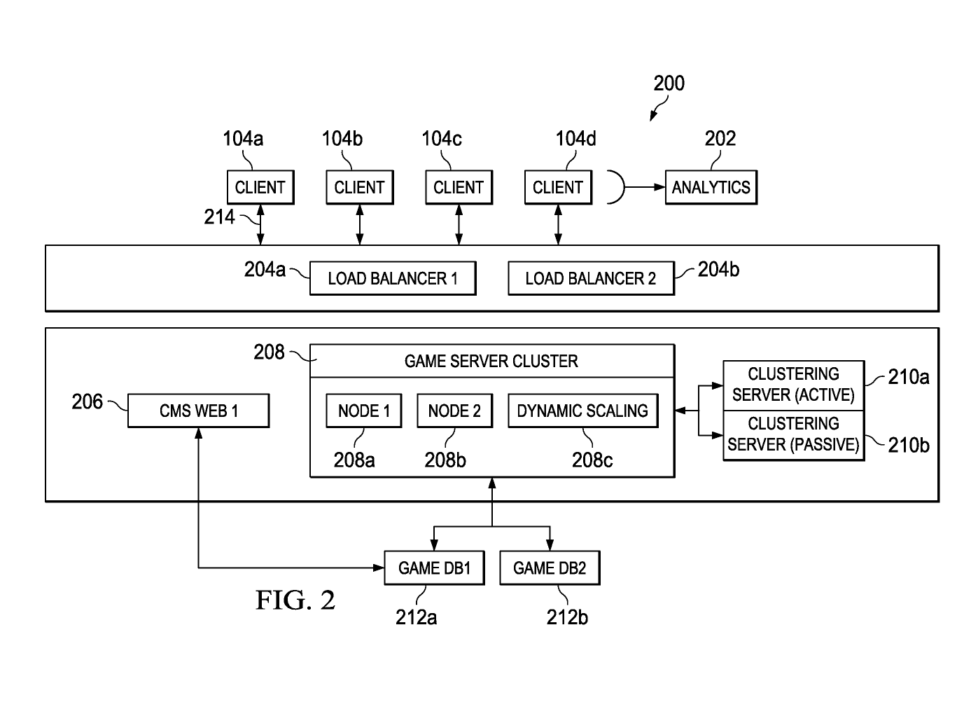

Turning now to FIG. 2, FIG. 2 is a block diagram illustrating an alternate MMOG system in accordance with some implementations of the present disclosure. In FIG. 2, game system 200 includes clients 104, analytics 202, load balancer 1 204a and load balancer 2 204b, Web content management system 206, game server cluster 208, node 1 208a, node 2 208b, dynamic scaling 208c, active clustering server 210a, passive clustering server 210b, game database 1 212a and game database 2 212b, and a network 214.

In some implementations, the game system 200 can execute one or more of the following: present information associated with players in a GUI environment; present trivia questions in the GUI; present trivia-related and non-trivia-related mini-games in the GUI; receive information identifying player-selected answers to trivia-based questions and mini-games, and to player-selected advertisements; display announcements to the player; present unique codes (e.g., barcodes, QR codes or an alphanumeric sequence) to be used for redemption purposes for prizes; and chat functionality between players, advertisers, and/or MMOG providers. In some implementations, game system 200 can implement trivia games and games of skill on mobile devices in arenas and in other venues. In some implementations, game system 200 can serve proprietary or licensed content for use in trivia games on mobile devices. In some implementations, game system 200 can implement a periodic MMO game that can played simultaneously via a mobile device, website, or TV with or without prizes on a periodic timeframe. For example, the periodic timeframe may be daily, weekly, monthly, annually, or other suitable periodic timeframe. While the following example description is centered on trivia games, the game system 200 can cover other topics associated with online games, such as military games, sports games, social games and/or other games.

In some implementations, game system 200 includes an analytics server 202. In some implementations, the analytics can be performed by an analytics server remote to the game system 200 (not illustrated). The analytics server may provide insight into how users interact with the MMOG and associated trivia-based game. The analytics server may also provide information pertaining to the service of advertisements on client 104 and the interaction of users to the served advertisements. Information provided by analytics server 202 may include usage statistics, frequency of use, session length, retention statistics, purchase tracking, demographics, geographic and user interest data, action conversion tracking and/or other suitable analytics features. While the illustrated implementation includes a single example analytics server 202, game system 200 can include any number of analytics servers 202.

In some implementations, analytics server 202 can synthesize data about a client game application's usage. In some implementations, analytics server 202 can provide Web-based tools to view and analyze system usage as well as native APIs to include within the client game application. In some implementations, the following components can be tracked and analyzed: [1] View Tracking—what views and sub-views of the app are heavily used. This will enlighten us as to the popularity of certain game modes within the game system; [2] Event Tracking—what in-game events are triggered often or seldom; [3] Commerce Tracking—what in-client game application purchases are being made. Are modes unlocked from redemption of in-game currency or with an actual purchase. In other implementations, other custom variables can be created.

In some implementations, game system 200 includes load balancers, load balancer 1 204a and load balancer 2 204b. In some implementations, the load balancing can be performed by a load balancing server remote to the game system 200 (not illustrated). The load balancing servers may distribute workload across multiple computers, a computer cluster (e.g., game server cluster 208 described below), network links, central processing units, disk drives, or other resources. The load balancers may provide optimal resource utilization, maximal throughput, minimal response times, and the avoidance of network overload. In some implementations, multiple load balancing servers can be used to increase reliability through redundancy. While the illustrated implementation includes example load balancer 1 204a and load balancer 2 204b, game system 200 can include any number of load balancers.

In some implementations, game system 200 includes a Web content management system (CMS) 206. In some implementations, the Web content management system functions can be performed by a Web content management system remote to the game system 200 (not illustrated). The Web content management system 206 may provide website authoring, collaboration, security, and administration tools. While the illustrated implementation includes a single example Web content management system 206, game system 200 can include any number of Web content management systems 206.

In order to serve both question content and themes (i.e. “skins”) to a mobile device, the content originates from Web CMS 206 in some implementations. In some implementations, Web CMS 206 has the: [1] Ability to be accessed via the web; [2] Ability to create a new Live event and give the event a name; [3] Ability to specify to the geo-location and radius of the event (an address may suffice); [4] Ability to specify a font style or styles for the event; [5] Ability to specify a color scheme for the Event; [6] Ability to upload a banner-sized graphic for display in the GUI; [7] Ability to upload a background graphic for display in the GUI; [8] Ability to configure game rules for the event (i.e. number of teams, player limit, time limits, etc.); [9] Ability to enter question and answer data that's unique to the event; [10] Ability to configure a prize or reward to the winner of the game.

In some implementations, the Web CMS 206 may also support creating unique user logins for authorized game administrators. Administrators may be granted a permissions-controlled account and access to the Web CMS 206 that would allow the administrator to create and configure their own Live events. In other implementations, creating unique user logins for authorized game administrators, the grant of a permissions-controlled account, and access to the Web CMS 206 to create and configure Live events can be performed by game server administration tools (not illustrated) or other system component(s).

In some implementations, game system 200 includes a game server cluster 208. In some implementations, a portion or the entire game server cluster can be remote to the game system 200 (not illustrated). The game server cluster includes game server cluster node 1 208a, game server cluster node 2 208b, and a dynamic scaling server 208c. In some implementations, game server cluster node 1 208a and game server cluster node 2 208b correspond to server 102 as described above. Dynamic scaling server 208c may provide a management platform for managing cloud infrastructure from multiple network (e.g., Internet) providers. The Dynamic scaling server 208c may also assist with the migration of network workload between private cloud-computing systems and automatically scales virtual server instances based upon network load using predefined parameters. While the illustrated implementation includes a single example game server cluster 208, game system 200 can include any number of game server clusters 208.

In some implementations, game system 200 includes active clustering server 210a and passive clustering server 210b. In some implementations, a portion or all of the clustering servers can be remote to the game system 200 (not illustrated). Active clustering server 210a and passive clustering server 210b may provide server and application clustering services for the game cluster server 208 as a runtime infrastructure service. In some implementations, multiple clustering servers can be used to increase reliability through redundancy. While the illustrated implementation includes example active clustering server 210a and passive clustering server 210b, game system 200 can include any number of clustering servers.

In some implementations, game system 200 includes a game database 1 212a and game database 2 212b. In some implementations, a portion or all of the game database servers can be remote to the game system 200 (not illustrated). The game database servers provide database functionality, data storage, and data backup functionality. In some implementations, game database 1 212a and game database 2 212b, correspond to memory 112 as described above. In some implementations, multiple game database servers can be used to increase reliability through redundancy. While the illustrated implementation includes example game database 1 212a and game database 2 212b, game system 200 can include any number of database servers.

In some implementations, network 214 can be similar to network 106 as described above.

While FIG. 2 is described as containing or being associated with a plurality of components, not all components illustrated within the illustrated implementation of FIG. 2 may be utilized in each implementation of the present disclosure. Additionally, at least one component described herein may be located external to game system 200, while in other implementations, certain components can be included within or as a portion of at least one described component, as well as other components not described. Further, certain components illustrated in FIG. 2 may be combined with other components, as well as used for alternative or additional purposes, in addition to those purposes described herein.

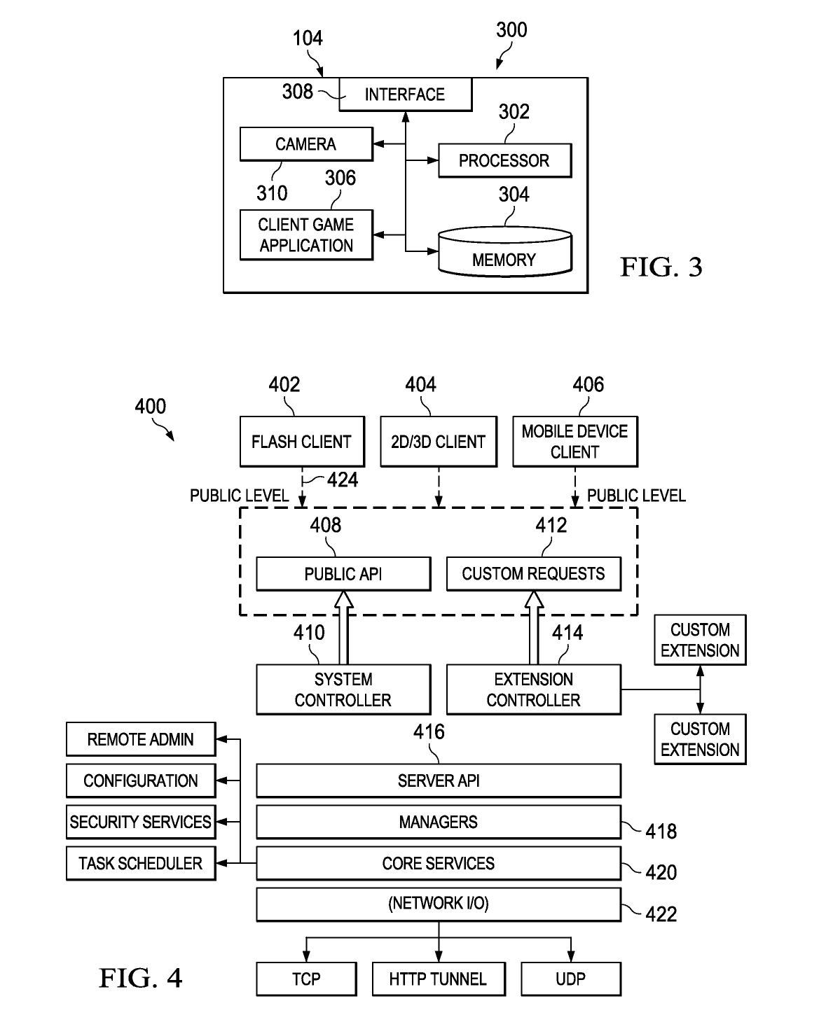

Turning now to FIG. 3, FIG. 3 is a block diagram illustrating components of an example MMOG system client 104 in accordance with some implementations of the present disclosure. At a lower level, in some implementations, each client 104 can include a processor 302, a memory 304, a client game application 306, an interface 308, and a camera 310.

In some implementations, processor 302 can be similar to processor 114 of the server 102. In other implementations, the processor 302 can be a processor designed specifically for use in client 104. Further, although illustrated as a single processor 302, the processor 302 may be implemented as multiple processors in the client 104. Regardless of the type and number, the processor 302 executes instructions and manipulates data to perform the operations of the client 104, including operations to receive and process information from the server 102 or other suitable data source, access data within memory 304, execute the client game application 306, operate the camera 310, as well as perform other operations associated with the client 104.

Similarly, memory 304 of the client 104 can be similar to memory 112 of the server 102. Memory 304 may include any memory or database module and may take the form of volatile or non-volatile memory including, without limitation, magnetic media, optical media, random access memory (RAM), read-only memory (ROM), removable media, or any other suitable local or remote memory component. For example, memory 304 may store a client game application 306, backup data, parameters, cookies, variables, algorithms, instruction, rules, or reference thereto. As illustrated, memory 304 can include any suitable components to interpret and decode messages received at the client 104. Further, although illustrated as a single memory 304, the memory 304 may be implemented as multiple memories in the client 104. The memory 304 may also store at least one user file, graphics rule, trivia question rule, and chat rule (not illustrated) similar to the user files 118, graphics rules 120, trivia question rules 124, and chat rules 126. Although illustrated as integral to client 104, memory 304 may also be physically or communicably connected to client 104. For example, memory 304 may be flash, optical, magnetic, or other suitable memory inserted into or connected to (e.g., by a cable) an interface port (not illustrated) on client 104.

The interface 308 of the client 104 may also be similar to the interface 103 of the server 102 in that it may comprise logic encoded in software and/or hardware in a suitable combination and operable to communicate with the network 106. More specifically, interface 308 may comprise software supporting at least one communication protocol such that the network 106 or hardware is operable to communicate physical signals to and from the client 104. Further, although illustrated as a single interface 308, the interface 308 may be implemented as multiple interfaces in the client 104.

At least one client game application 306 is illustrated within the client 104. The client game application 306 can be any application, program, module, process, or other software that may execute, change, delete, generate, or otherwise manage information associated with a particular client 104 in relation to interfacing with the MMOG and an associated trivia-based game system. Additionally, a particular client game application 306 may operate in response to and in connection with at least one request received from other client game applications 306, including a client game application 306 associated with another client 104. In some implementations, the client game applications 306 can operate in parallel. In some implementations, each client game application 306 can represent a web-based application sending and receiving data via the network 106 (e.g., through the Internet, or via at least one cloud-based service). Moreover, any or all of a particular client game application 306 may be a child or sub-module of another software module or application (not illustrated) without departing from the scope of this disclosure. Still further, portions of the client game application 206 may be executed or accessed by a user working directly at the client 104, as well as remotely at a corresponding client 140 or server 102. Client game application 306 may be available from an application store, online download, manual installation via optical or flash memory, and/or other suitable method.

Camera 310 of the client 104 is operable to capture image data from sources external to client 104 for use with client game application 306. For example, a user may use camera 310 with client game application 306 to scan a barcode or other image data to initialize and/or join a trivia game, take a self-portrait for a user account, etc. In some implementations, camera 310 can use a lens assembly with a variable diaphragm to focus light onto an electronic image sensor and digitally record image information into memory 304 in various digital file formats. For example, digital file formats used to record the image information may be JPG, GIF, BMP, TIFF, PNG, AVI, DV, MPEG, MOV, WMV, RAW, or other suitable digital file format. In some implementations, the electronic image sensor can be a charge coupled device (CCD), an active pixel sensor (CMOS), or other suitable electronic image sensor. Camera 310 may provide a live preview of the external image source to be photographed. Camera 310 may also provide optical and/or digital zoom functionality and panoramic images in both two and three dimensions. In other implementations, the recorded image information can be both still and video with sound. In still other implementations, the camera 310 can geo-tag captured image information. Image information recorded by camera 310 may also be transferred over network 106 to a remote data storage location (not illustrated) instead of being stored in memory 304. Although illustrated as integral to client 104, camera 310 may also be physically or communicably connected to client 104. For example, camera 210 may be inserted into or connected to (e.g., by a cable) an interface port (not illustrated) on client 104. The camera 310, however, is not a required component in some implementations of the present disclosure.

While FIG. 3 is described as containing or being associated with a plurality of components, not all components illustrated within the illustrated implementation of FIG. 3 may be utilized in each implementation of the present disclosure. Additionally, at least one component described herein may be located external to client 104, while in other implementations, certain components can be included within or as a portion of at least one described component, as well as other components not described. Further, certain components illustrated in FIG. 3 may be combined with other components, as well as used for alternative or additional purposes, in addition to those purposes described herein.

While FIG. 3 is described as containing or being associated with a plurality of components, not all components illustrated within the illustrated implementation of FIG. 3 may be utilized in each implementation of the present disclosure. Additionally, at least one component described herein may be located external to the client 104, while in other implementations, certain components can be included within or as a portion of at least one described component, as well as other components not described. Further, certain components illustrated in FIG. 3 may be combined with other components, as well as used for alternative or additional purposes, in addition to those purposes described herein.

Turning now to FIG. 4, FIG. 4 is a block diagram of a MMOG platform 400 in accordance with some implementations of the present disclosure. At a lower level, in some implementations, a MMOG platform 400 can include a flash client 402, a 2D/3D client 404, a mobile device client 406, public application programming interface (API) 408, system controller 410, custom requests 412, extension controller 414, server API 416, managers 418, core services 420, network I/O 422, and a network 424.

Clients 402-406 are any suitable application software running on the client 104 that manages flash or similar functionality, 2D/3D graphical functionality, and trivia game functionality, respectively, on various clients 104 as described above.

The server side API's 416 and custom requests 412 are engineered to interface with multiple client 104 operating systems described above. The public API 408 exposes standard functionality directly to the client 104. Server-side API 416 and extensions 414 are server-side game logic coded to handle requests and events. For example, the server-side API 416 and extension 414 may be coded in Java or any other suitable software language.

Zones are used to host single multiplayer games on the server. Each zone can have its own database connection and server extensions for use in private branding functions.

Managers 418 and core services 420 provide essential services such as configuration, logging, security, task scheduling, zone/room/user management, buddy/chat lists, banned user management, remote administration, and other suitable services.

The network engine 422 provides TCP/UDP connectivity, session management, and security. While illustrated with TCP/UDP, the MMOG platform 400 can support any suitable network communication protocol. In some implementations, network engine 422 uses a binary protocol in order to reduce bandwidth usage and data parsing. The binary protocol also performs on-the-fly compressions if necessary to keep bandwidth within a predefined limit.

In some implementations, network 424 can be similar to network 106 and network 214 as described above.

While FIG. 4 is described as containing or being associated with a plurality of components, not all components illustrated within the illustrated implementation of FIG. 4 may be utilized in each implementation of the present disclosure. Additionally, at least one component described herein may be located external to MMOG platform 400, while in other implementations, certain components may be included within or as a portion of at least one described component, as well as other components not described. Further, certain components illustrated in FIG. 4 may be combined with other components, as well as used for alternative or additional purposes, in addition to those purposes described herein.

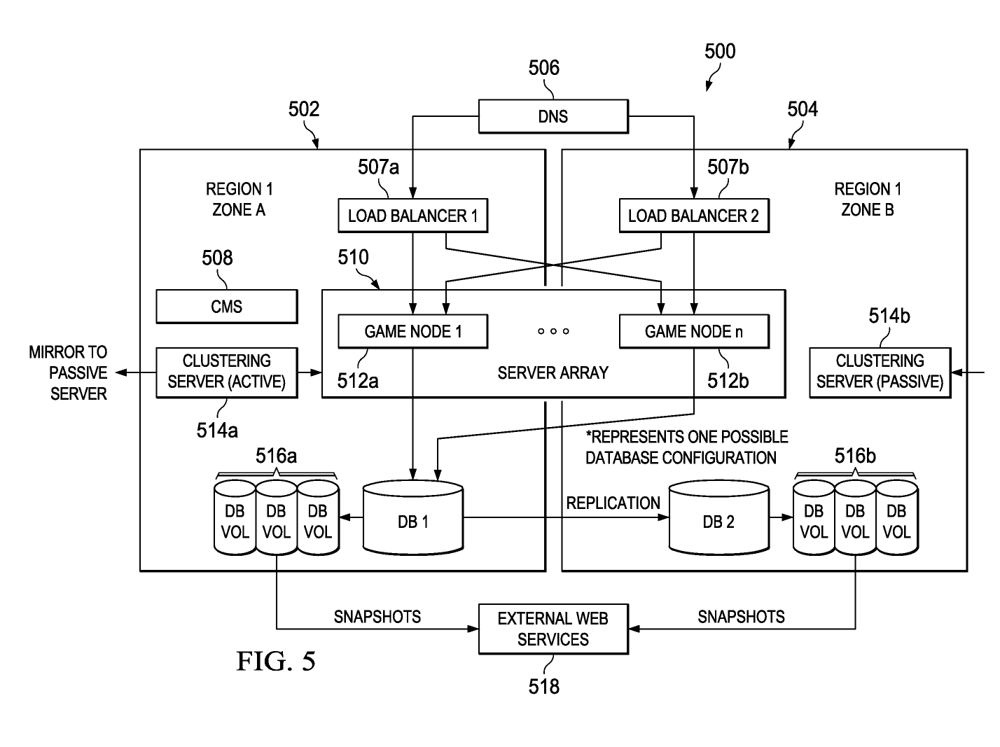

Turning now to FIG. 5, FIG. 5 is a block diagram illustrating an alternative MMOG system 500 in accordance with some implementations of the present disclosure. In the illustrated implementation of FIG. 5, game system 500 includes DNS server 506, load balancer 1 507a and load balancer 2 507b, Web CMS 208, server array 510, game node 1 512a, game node 2, 512b, active clustering server 514a, passive clustering server 514b, zone A game database cluster 516a, zone B game database cluster 516b, and external web services 518.

In some implementations, game system 500 is divided into two zones, Zone A 502 and Zone B 504, that make up a region (not illustrated), although any number of zones are possible. In some implementations, network requests will be balanced across the separate zones. In some implementations, each zone can be implemented at different physical data centers or geographically separated (i.e., in separate or similar regions) for at least disaster recovery functionality. In other implementations, the different zone can be implemented at the same physical data center. Network requests may equally balance across both zones. However, if one datacenter goes down, or a problem exists with a key game system 500 components (e.g., game node 1 512a or clustering server 514a), redundancy exists for game system 500 to continue operations with minimal impact. In some implementations, zone A 502 will be the primary site with an active clustering server 514a, Web CMS 508, and serving all database data from the zone A database cluster 516a. All database changes made on zone A database cluster 516a may be replicated on zone B database cluster 516b. In some implementations, zone B will be a secondary site running game node n 512b as well as a hot failover zone B game database cluster 516b and a passive clustering server 514b in case of game node 1 512a failure. In some implementations, a second Web CMS (not illustrated) in zone B 504 may be activated if zone A CMS 508 fails.

In some implementations, game system 500 includes a domain name system (DNS) server 506. The DNS server provides access to a hierarchical distributed name system that associates various types of information with network (i.e., Internet) domain names assigned to each participating entity. While the illustrated implementation includes a single example DNS server 506, game system 500 may include any number of DNS servers.

In some implementations, game system 500 includes load balancers load balancer 1 507a and load balancer 2 507b. In some implementations, the load balancing can be similar to load balancer 1 204a and load balancer 2 204b as described above. While the illustrated implementation includes example load balancer 1 507a and load balancer 2 507b, game system 500 may include any number of load balancers.

In some implementations, game system 500 includes a Web CMS 508. In some implementations, the Web CMS 508 can be similar to Web CMS 206 as described above. While the illustrated implementation includes a single example Web CMS 508, game system 500 can include any number of Web CMS.

In some implementations, game system 500 includes a server array 510. In some implementations, the server array 510 can be similar to game center cluster 208 as described above. In some implementations, a portion or the entire server array 510 can be remote to the game system 500 (not illustrated). While the illustrated implementation includes a single example server array 510, game system 500 can include any number of server arrays.

In some implementations, game system 500 includes active clustering server 514a and passive clustering server 514b. In some implementations, a portion or all of the clustering servers can be remote to the game system 500 (not illustrated). Active clustering server 514a and passive clustering server 514b may be divided among different zones as described above. In some implementations, the active clustering server 514a and passive clustering server 514b can be similar to active clustering server 210a and passive clustering server 210b as described above. While the illustrated implementation includes example active clustering server 514a and passive clustering server 514b, game system 500 can include any number of clustering servers.

In some implementations, game system 500 includes a game database 1 516a and game database 2 516b. In some implementations, a portion or all of the game database servers can be remote to the game system 500 (not illustrated). The game database servers may provide database functionality, data storage, and data backup functionality similar to game database 1 212a and game database 2 212b as described above. While the illustrated implementation includes example game database 1 516a and game database 2 516b, game system 500 can include any number of database servers.

In some implementations, game system 500 includes external web services 518 providing cloud computing functionality. While the illustrated implementation includes single example external web services 518, game system 500 can include any number of external web services.

In some implementations, game system 500 can make use of elastic Internet protocol (IP) addresses. In the event of a game system 500 component failure, another component within the same zone may be made available with minimal downtime. In other implementations, the server array 510 can automatically expand or shrink based on performance metrics and can further expand or shrink evenly across available zones in a region.

While FIG. 5 is described as containing or being associated with a plurality of components, not all components illustrated within the illustrated implementation of FIG. 5 may be utilized in each implementation of the present disclosure. Additionally, at least one component described herein may be located external to game system 500, while in other implementations, certain components may be included within or as a portion of at least one described component, as well as other components not described. Further, certain components illustrated in FIG. 5 may be combined with other components, as well as used for alternative or additional purposes, in addition to those purposes described herein.

In some implementations, an example workflow for game system 500 can be: [1] Traffic from clients (not illustrated) is distributed across the load balancing servers layer by round-robin DNS; [2] The load balancing layer 507a and 507b then distributes the traffic across a scaling array of game server nodes 512a and 512b; [3] The game servers 512a and 512b share heap/session state via clustering servers (one active server 514a, one passive server 514b); [4] Two databases 516a and 516b, with a replication configuration to be determined during the implementation phase, handle database requests from the game server nodes 512a and 512b and one additional CMS server (not illustrated); [5] The database servers 516a and 516b store their data across a number of volumes and perform snapshots to external web services 518 for backup purposes on an agreed upon schedule.

In some implementations, trivia-game logic can be implemented as described in Table 1:

TABLE 1
CUSTOM EXTENSION METHODS

| Method | What does it do? |
|---|---|
| Init( ) | Called when extension is loaded |
| | Contains initialization code |
| handleRequest( ) | Handles client request. Receives 4 parameters: |
| | cmd: String that identifies the action the extension |
| | will perform. Should be short as possible to |
| | conserve bandwidth. Ex: “updatePlayers” |
| | would be “updPLA”. (#ACTION: |
| | What # of characters do we want |
| | to agree on) . . . |
| | params: Object containing data sent from client. |
| | Nums, strings, bools, arrays, and objects. |
| | User: User object representing client that sent the |
| | request |
| | fromRoom: ID of room where request is coming |
| handleInternalEvent( ) | Handles server events. |
| | Server alls this method in extension by passing |
| | a name property that identifies event. |
| | Examples include: userjogin, userExit, userLost, |
| | newRoom, roomLost, loginRequest, |
| | spectagorSwitched |
| Destroy( ) | Called when extension is going to be destroyed |
| | by server |
| | Clear all setIntervals( ) you created previously. |

Custom extensions can be used for server-side programming, the custom extensions communicate to at least the server-side API that can encapsulate database access and trivia-game logic. In this implementation, clients 104 communicate only with the public API 408 and custom requests 412.

In some implementations, key architecture components can be implemented as described in Table 2:

TABLE 2

| Component | Provides |
|---|---|
| Client Tier | Client (e.g. mobile device), applications to play the |
| | trivia-game |
| App Tier | Server-side “platform” to run game logic and manage |
| | communications. |
| | Provides core MMO features and admin tools. |
| Data Tier | Back-end database management system to store and |
| | delivery persistent data |
| Hosting | Environment to host virtual servers that run the game |
| | system |

Game Modes

In some implementations, the game system can provide various trivia-game modes providing different trivia-game functionality. In some implementations, trivia-game modes may vary, be mixed with other trivia-game modes, vary in numerical parameters (e.g., questions to be answered, timing amounts, scores, etc.) and may delete and/or add other appropriate steps consistent with the trivia-game functionality described below without departing from the scope of the present disclosure.

With Friends (WF) Mode

In WF mode, players take turns challenging their friends and/or random opponents in rounds of trivia questions. The turn-based nature of this mode lends itself nicely to short gameplay sessions that allow the user to take their turn at their convenience. In some implementations, an example gameplay scenario would include, [1] Player launches application; [2] From a Main Menu, Player selects “With Friends”; [3] The player is met with a login/registration screen. From here they can log in with existing credentials or sign up to play; [4] Player has two options—“Play Now” or “Challenge a Friend”. The first option will match the player with any available opponent. The second option will let the player browse through a friend list and issue a challenge; [5] In either case, the first trivia question/genre is a toss-up, meaning that a random genre is chosen for the initial question. Each player gets the same question. The countdown timer for each question begins as soon as the question is revealed (not delivered). As soon as an answer is selected and a score is tallied for the round, the Challenger is notified that it is their turn to answer the question if they haven't already (The notification would occur via a notification or similar functionality; this way it's easy for the challenger to respond immediately by acknowledging the notification or to wait until they have a free moment); [6] After both players have responded to the same question, a scoreboard for the match is displayed. Both players will know who is in the lead before the next round begins. Whoever answered the question correctly AND the fastest wins the round and gets to select the next trivia genre; [7] After the point scores are totaled, players are given any bonus power-ups and achievements that they've earned.

This sequence repeats in the same fashion for a determined number of rounds, or a determined number of questions of mixed genres. The only exception is that beginning in a predetermined round the trivia genre selection rotates between players. Only the winner of another predetermined round gets to select the genre as a reward for getting the higher score.

Scoring: Each round of With Friends mode has a possible score of 1,000 points. This max point total will begin to decrease moments after the question is revealed, thus each player must answer quickly in order to get as many points as possible. A correct answer's score is based on how quickly the player makes the selection. Making a correct selection with a full timer results in 1000 points, a ¾ timer results in 750 points, a ½ timer 500 points, and a ¼ timer 250 points. Points are also relative to the fraction of seconds left on the timer×100 (e.g. 7.5 seconds would result in 750 points). Choosing an incorrect answer is worth zero points and there is no penalty for selecting a wrong answer. Bonuses will be given for scoring streaks beginning at three consecutive rounds of selecting a correct answer. At this point the maximum possible points goes up to 1,200 until the streak is broken. A player's total match score is determined from the accumulation of each round, any bonus scores, plus 5,000 points for winning the match. The maximum score allowed for winning a 20-round match is 28,400 points: 3,000 points+20,400 points+5,000=28,400 or 3,000 points for answering perfectly in rounds 1-3, plus 20,400 for answering perfectly and getting a bonus streak in rounds 4-20, plus 5,000 points for winning the match.

Rules and Objectives: Players must choose one answer out of four choices during a round. If a player is unable to make a selection before the ten-second timer runs out they will receive a zero score for the round. There will be a limit of five concurrent With Friends matches per player. It remains to be seen if there will need to be a cap on number of WF matches per day, though this concept might prove valuable to limit the amount of questions a player might answer over the course of the day to mitigate content attrition (i.e. if a player is playing all day there could be a chance that they begin to get repeat trivia questions. By limiting how often they can play With Friends we can curb the likelihood of this happening). Any With Friends match that has been inactive for more than seven days would be considered stale; these matches should get culled from the players' queue in order to free up space for other matches. Overall scores are cumulative. At the start of a With Friends match, the score is zero-to-zero. In the event of a tie, players will face off in a “sudden death” round to arbitrate the tie. The objective of WF mode is to not only defeat your opponent, but to also score as many points as possible. Even if you don't win the match, your score is taken into account when it comes to leaderboards, achievements, etc. Winners of each match are rewarded with 5,000 bonus points or the equivalent of answering five questions correctly with the maximum time left. The cumulative score, or point total, will trigger the earning of tokens when milestones are hit. Tokens can be spent within an online store.

Game Modifiers: Throughout the course of a WF match, players can choose from several Game Modifiers or “Power-ups” that cause different effects within the current round. Some modifiers come standard with the start of a match while other premium “power-ups” have to be earned or purchased from the online store. Each power-up can be selected as soon as a question is revealed or during the timer countdown. Standard Modifiers: These power-ups are granted at the beginning of every With Friends match and can each be used a single time. Stop the Clock! (one per match)—This power-up effect pauses the timer for eight consecutive seconds. Skip it (one per match)—This power-up effect skips the current question and gives the player points for answering it correctly. 50/50 (one per match)—This power-up takes away two possible choices and leaves the player with two possibilities (one is the correct answer; the other is an incorrect answer). Premium Modifiers: These power-ups are only granted at the beginning of a With Friends match if they've been earned or purchased by the player and can only be used a single time. Text a Friend (one per match)—This power-up effect pauses the current round and pulls up the player's address book. The player is allowed to select a contact which will then launch an in-app SMS with the trivia question and choices pre-populated in the composition field. Once the player sends the text message, they have just one minute to respond to the current answer before the round expires for them, in which case they would receive a score of zero if they take longer than one minute.

Live! Mode

In Live! mode, players in the same geo-location compete in real-time for prizes (of the non-virtual kind) Access to this mode is restricted based on a player's location where they'll only be eligible to compete if their current location falls within the “geo-fence” of the event. This mode supports a dynamic amount of players, from small events at bars and restaurants to large-scale gatherings such as professional sporting events. Depending on the configuration of the event, players compete as individuals or as squads. In other words, the admin page of the event will allow the creator to specify ‘No Teams,’ “two teams,” “three teams,” and so on. The admin may or may not want to specify team sizes and should have the option to not limit the number of players per team. Players will find events by navigating to the Main Menu in the client game application and selecting “Live!” They can view a list of events; events that they're eligible for within their location appear active while events that are outside of their location appear inactive or invisible.

An example gameplay scenario 1 (a small scale event at a local pub) includes: [1] Player enters the venue, realizes there is a trivia night tonight; [2] Player downloads the client game application from an online store (as instructed by in-venue signage that accompanies the trivia night) or simply launches the application if already installed; [3] Player launches the client game application and selects “Live” from the Main Menu; [4] The player is met with a login/registration screen. From here they can log in with existing credentials or sign up to play; [5] Player sees a list of events; active events within their current location filter to the top of the list. The player sees that the trivia night at the pub begins in five minutes and taps on the event to join it; [6] Once the player has joined the session that's about to start, they see that this event is set up with ten teams of four members. The player taps on a team that is short one member and joins it [7] As soon as the teams fill up or the event countdown timer reaches zero, the trivia event begins; [8] On screen each player sees the question for round 1. They also see that their teammates are participating in the round with them as their names are displayed on screen. Each player on a team can select an answer on their own accord and these choices are reflected on screen in real-time; [9] The round countdown timer begins to tick down from ten seconds moments after the question is revealed; [10] As soon as all teammates have made their selection or the countdown timer runs out, the correct answer to the question is revealed; [11] In this case, only two out of the four team members got the answer correct and the team receives 500 points for the round; [12] A scoreboard is revealed that shows all of the teams and their ranking based on the previous round. Individuals are not ranked in this mode; [13] This cycle repeats until the end of the event; [14] The winning team is then awarded their prize for achieving the highest score in the event.

An example gameplay scenario A (a large scale venue or event, i.e. sporting event) includes: [1] Player enters the venue, realizes there is a trivia event happening at the venue during the game. [2] Player downloads client game application from the online store (as instructed by in-venue signage that accompanies the trivia night); [3] Player launches the client game application and selects Live from the Main Menu; [4] The player is met with a login/registration screen. From here they can log in with existing credentials or sign up to play; [5] Player sees a list of events; active events within their current location filter to the top of the list; [6] A countdown timer lets the player know when the trivia match begins. Right now the sporting event the player is attending has not yet begun. The live trivia match, however, begins in two minutes; [7] As soon as the trivia event starts the player receives a notification to let them know (this would launch the app if the player does not have it open already); [8] The player is presented with the question for round 1; [9] Moments after the question is revealed a countdown timer starts to tick down from ten seconds; [10] The player chooses the answer they feel is the correct one. After the timer reaches zero the correct answer is revealed and the player is awarded a score accordingly; [11] After the round a scoreboard is displayed that shows the top fifteen scores and the player's ranking at the bottom (if they're not in the top fifteen); [12] At this point the game may move directly to the next round or a “We'll be right back!” message is displayed on screen; [13] The procession of rounds will play out in the same manner as listed above until the game concludes; [14] At the conclusion of the game, (and after each round), a scoreboard displays on screen; [15] The player with the highest score at the conclusion of the event wins and is awarded a prize.

Scoring (Team Mode/Individual Mode)

Team Mode: In Team or Squad mode, scoring does not depend on any particular individual—it's all about cooperative team play. Each round of team based Live mode has a possible score of 1,000 points. Unlike other game modes, the max score is not affected by how quickly players submit their answer; everyone still has ten seconds to submit their answer, though. Rather, scores decrease from 1,000 depending on the percentage of users that got the answer correct as opposed to incorrect. The scoring equation might look something like this: Let's say a team consists of ten players. The team receives a question and each individual responds with what they believe is the correct answer. Six players choose the correct answer, and four get it incorrect. In this case, the team would score (out of 1,000) 600 points for six/ten players. In other words, (number of players who answered correctly divided by the number of players on the team)×1000.

Points will be rounded up or down accordingly. Points will not be in fractions. Another example would be in a large scale scenario where one group of fans is competing against another group of fans. There are 11,221 people on Team A and 9,489 people on Team B. Scoring might look like this: Both teams answer the question in real-time. On Team A, 9,590 people got the right answer and on Team B 8,321 people got the right answer. Team A would score 854 points and Team B would score 876 pts. Team B wins the round. This was calculated with the above formula of (number of players who answered correctly divided by the number of players on the team)×1000. Choosing an incorrect answer is still worth zero points and there is no penalty for selecting a wrong answer. Individual players on the team will have a negative effect if they score zeroes. Bonuses will be given for team scoring streaks beginning at three consecutive rounds of selecting a correct answer. At this point the maximum possible points goes up to 1,200 until the streak is broken. The maximum team score allowed for winning a 25-round match is 28,2000 points: 3,000 points+25,200=28,200 or 3,000 points for answering perfectly in rounds 1-3, plus 25,200 for answering perfectly and getting a bonus streak in rounds 4-25.

Individual Mode: Each round of Live mode has a possible score of 1,000 points. This max point total will begin to decrease moments after the question is revealed, thus each player must answer quickly in order to get as many points as possible. A correct answer's score is based on how quickly the player makes the selection. Making a correct selection with a full timer results in 1000 points, a ¾ timer results in 750 points, a ½ timer 500 points, and a ¼ timer 250 points. Points are also relative to the fraction of seconds left on the timer×100 (e.g. 4.3 seconds would result in 430 points). Choosing an incorrect answer is worth zero points and there is no penalty for selecting a wrong answer. Bonuses will be given for scoring streaks beginning at three consecutive rounds of selecting a correct answer. At this point the maximum possible points goes up to 1,200 until the streak is broken. The maximum score allowed for winning the 25-round match is 28,200 points: 3,000 points+25,200=28,200 or 3,000 points for answering perfectly in rounds 1-3, plus 25,200 points for answering perfectly and getting a bonus streak in rounds 4-25.

Rules and Objectives: Access to the Live mode is restricted to players who are in a “zone” or geo-fenced area in or around the venue. Players can join the Live/Event mode when it is in-progress; however they will join at the game's current state and not from the beginning of round 1. Before a Live event begins, players can join and side with a team (if applicable) up to five minutes prior to the game's start. The number of teams in an Event can vary from 2 to 20 (or more) with a varying amount of players per team. Unbalanced teams should be allowed, so if a team consists only of an individual that would be fine. Since scoring is relative to the percentage of correct respondents, each team's score will still depend on who gets correct answers as opposed to incorrect answers. In each round, players must choose one answer out of four choices. If a player or team is unable to make a selection before the ten-second timer runs out they will receive a zero score for the round. During Live mode, only standard power-ups can be applied. The player should be discouraged from leaving the app once a Live round has begun. Leaving the app will result in a penalty. If a round is currently active and the user leaves the app they will automatically get the active question wrong and will receive a zero score for the round. This is to discourage cheating of any kind when questions are active. In team mode if a player on a team leaves the app during a live round they forfeit their opportunity to provide a response and receive a zero score. Scoring is cumulative through rounds 1-20 (or more/less rounds depending on the configuration of the game). The player/team's objective is to get the highest possible score for each round so that they come out on top of the scoreboard at the conclusion of the event. If there is a tie at the top of the scoreboard at the end of round 20, qualifying players/teams will move on to a sudden death “overtime” mode to arbitrate the tie. At the conclusion of Live mode, the scoreboard for the event is shown and the winner of the event is declared. The winner will then be contacted by the trivia game provider so that they can claim their prize. Cheating of any kind will automatically disqualify the player or team from Live mode, and future banning of accounts is up to the trivia game provider's discretion.

Game Modifiers: Only Standard Modifiers apply in Live mode. These power-ups are granted at the beginning of every Live match and can each be used a single time. For Teams, each player on the team receives one power-up per live event. Stop the Clock! (one per Live mode)—This power-up effect pauses the timer for 8 consecutive seconds. Skip it (one per Live mode)—This power-up effect skips the current question and gives the player points for answering it correctly. 50/50 (one per Live mode)—This power-up takes away two possible choices and leaves the player with two possibilities (one is the correct answer; the other is an incorrect answer). Survey Says (one per Live mode)—a variation on Sneak-a-Peek for the large-scale modes; allows you to see a sampling of other people's answers, Family Feud-style. Emphasizes the social aspect of the game and brings home the feeling of being part of a larger event.

Game-of-the-Week (GOTW) Mode

GOTW mode, is a once-a-week event where players compete in real-time for prizes (of the non-virtual kind) Access to this mode is restricted and players must unlock the game mode in the online store by using tokens earned in-game or purchased in the online store. An example gameplay scenario includes: [1] Player launches client game application; [2] Player selects “Game of the Week” (note: This mode will not be active until moments before the event. In all other times a countdown timer will display in the main UI to show when the next GOTW event will begin); [3] The player is met with a login/registration screen. From here they can log in with existing credentials or sign up to play; [4] A “Welcome” screen appears that explains the rules and reveals the prize for this week's “GOTW.” Game is synced and “GOTW” mode begins; [5] Round 1 of 20 starts when the first trivia question is revealed. The player has a moment to read the question before the round timer starts to tick down from ten seconds; [6] After the player chooses their answer they must wait for the round to finish (i.e. ten seconds after timer starts); [7] The correct answer is then revealed and player scores are calculated. A real-time scoreboard displays the player's overall ranking; [8] The next round begins, and this cycle repeats until the end of round 20 when; [9] “GOTW” ends. The player at the very top of the scoreboard wins the event and its prize.

Scoring: Each round of “GOTW” mode has a possible score of 1,000 points. This max point total will begin to decrease moments after the question is revealed, thus each player must answer quickly in order to get as many points as possible. A correct answer's score is based on how quickly the player makes the selection. Making a correct selection with a full timer results in 1000 points, a ¾ timer results in 750 points, a ½ timer 500 points, and a ¼ timer 250 points. Points are also relative to the fraction of seconds left on the timer×100 (e.g. 4.3 seconds would result in 430 points). Choosing an incorrect answer is worth zero points and there is no penalty for selecting a wrong answer. Bonuses will be given for scoring streaks beginning at three consecutive rounds of selecting a correct answer. At this point the maximum possible points goes up to 1,200 until the streak is broken. The maximum score allowed for winning the 20-round match is 28,200 points: 3,000 points+20,400=23,400 or 3000 points for answering perfectly in rounds 1-3, plus 20,400 points for answering perfectly and getting a bonus streak in rounds 4-20.

Rules and Objectives: Access to this game mode is restricted to players who have unlocked the game mode via purchase with tokens in the online store. The “GOTW” mode will occur once every Tuesday, and the prize for the week's match will be revealed via the app's UI at midnight on Tuesday. When each round of “GOTW” begins players must choose one answer out of four choices. If a player is unable to make a selection before the 10 second timer runs out they will receive a zero score for the round. During “GOTW” mode, only standard power-ups can be applied and all players begin the match with the exact same power-ups which can each be used once per match. The player should be discouraged from leaving the app once the “GOTW” has begun. Leaving the app will result in a penalty. If a round is currently active and the user leaves the app they will automatically get the active question wrong and will receive a zero score for the round. This is to discourage cheating of any kind when questions are active. Scoring is cumulative through rounds 1-20. The player's objective is to get the highest possible score for each round so that they come out on top of the scoreboard at the conclusion of “GOTW.” If there is a tie at the top of the scoreboard at the end of round 20, qualifying players will move on to a sudden death “overtime” mode to arbitrate the tie. At the conclusion of “GOTW” mode, the scoreboard for the event is shown and the winner of the week is declared. The winner will then be contacted by the trivia-game provider so that they can claim their prize. Cheating of any kind will automatically disqualify the player from “GOTW” mode, and future banning of accounts is up to the trivia game provider's discretion.

Game Modifiers: Only Standard Modifiers apply in “GOTW” mode. These power-ups are granted to all players at the beginning of every “GOTW” match and can each be used a single time. Stop the Clock! (one per “GOTW”)—This power-up effect pauses the timer for 8 consecutive seconds. Skip it (one per “GOTW”)—This power-up effect skips the current question and gives the player points for answering it correctly. 50/50 (one per “GOTW”)—This power-up takes away two possible choices and leaves the player with two possibilities (one is the correct answer; the other is an incorrect answer). Survey Says (one per “GOTW”)—a variation on Sneak-a-Peek for the large-scale modes; allows you to see a sampling of other people's answers, Family Feud-style. Emphasizes the social aspect of the game and brings home the feeling of being part of a larger event.

Social Game Show (SGS) Mode

In SGS mode, a virtual online game show is established where multiple players can complete simultaneously via television, the Internet, mobile device, or other suitable device for cash and other real prizes.

Supporting Systems

User Registration and Accounts

In order to participate in any game mode users are required to register and create an account with the following: Username, Email Address, Phone Number (optional), User Pic (from photo library), Password, Confirm password, Newsletter opt-in. Upon registration all users will receive a welcome email. Users are encouraged to provide a real email address in order to be eligible for prizes; otherwise there may be no way to get in touch with the person. All user registration data will be captured and stored in a secure database. In addition to creating an account, users can simply log in with their Facebook credentials via the Facebook Connect API for convenience. This will enable users to challenge their Facebook friends to WF challenges as well as view friends-only leaderboards. On the device, users will stay signed in by default and must explicitly tap a “logout” button in the client game application to sign off

Difficulty Level/Handicap

Trivia questions themselves may be rated easy, medium, and hard, but this will not be exposed to end users. As a means of keeping the playing field even, questions of varied difficulty will be distributed evenly in all game modes. In some implementations, questions may be presented in any order, amounts, and difficulty level depending upon, for example, system parameters, dynamic game play, pre-determined trivia game types, parameters, difficulty level, or other suitable method of determination.

Leaderboards

A leaderboard system tracks player scores throughout different gameplay modes to show players where they rank in comparison with other players. During all gameplay modes, a real-time Leaderboard, or scoreboard for the match, should display at the end of every round. It's important to note that overall player scores will be cumulative to encourage long term play; however match scores always begin at zero for all players. The following are leaderboard category types that players can access while playing the trivia-game: Friends Leaderboard: This leaderboard displays ranks (1st place, 2nd place, 3rd place) players in comparison to how their friends scored. Local (esp. for Live) Leaderboard: This leaderboard displays ranks (1st place, 2nd place, 3rd place) of players within a certain geo-location based on match score. Regional Leaderboard: This leaderboard displays ranks (1st place, 2nd place, 3rd place) of players within a certain geological region (North, South, East Coast, West Coast, and Midwest). National: This leaderboard displays ranks (1st place, 2nd place, 3rd place) of players at a national level (i.e. United States). Global: This leaderboard displays ranks (1st place, 2nd place, 3rd place) of all players.

All Leaderboards can be sorted by time as well since scoring in certain modes is cumulative. Players can filter each leaderboard by the following time frames: Daily Leaderboard: Scores filtered by location and the current day. Weekly Leaderboard: Scores filtered by location and the current week. All Time Leaderboard: Scores filtered by location with no time filter to show total cumulative scores.

Notifications

It will be a requirement to notify players of certain in-game events such as the beginning of rounds or which player's turn it is in WF mode. The following example events illustrate how and why a user would receive a notification. Example 1—WF mode: [1] Two players are playing WF mode against one another. Since this mode is turn-based, players may not be answering questions for rounds at the same time; [2] Player A submits their response to a question first. As soon as this happens, [3] Player B receives a notification on their phone that it is their turn to respond. They don't necessarily have to take their turn immediately, but acknowledging the notification will launch the client game application and take them directly to the WF match in progress; [4] this cycle continues in With Friends mode so that each player knows when the other has taken their turn. Example 2—Live mode: [1] A group of players are playing Live mode at a hockey game; [2] The group has already played through 4 rounds of questions. The next round of questions is going to start at the beginning of the 1st period intermission; [3] Moments after the horn sounds to signify the end of the 1st period of play, players in Live mode all receive a notification that round 5 is starting; [4] Since Live mode is in real-time, the game begins as soon as a Live event administrator starts the round; [5] Players can acknowledge the notification or launch the client game application and resume Live mode to continue the game and start round 5; [6] This cycle continues in Live mode. In some implementations, the display of the notification may be suppressed if the player has the client game application open so as to not distract the player. Example 3—There is a live event on a Saturday: [1] A player who has previously participated in a live event may receive a notification as a reminder of an upcoming event; [2] A game admin can send the notification to specific devices or all devices to let them know, for example, that they should “Come out and play Live at this Saturday's Dallas Stars Game. Winner will receive 6 free tickets to a game of their choice this season!”

Mobile Ads

In some implementations, the game system will include integration of at least one mobile ad network as a means of creating revenue from usage of the client game application. Banner style ads will appear in the game's main menu as well as on select screens during game modes. Different types of advertisements and advertisement methods may be used. Various advertisement services may be used. In some implementations, advertising can be determined based upon location (i.e., geo-determination) and/or the provider of the trivia game (i.e., “house” advertisements).

Achievements

Achievements are earned throughout the trivia game by performing certain actions and hitting milestones. These achievements show up when the user views their game stats or another player's stats. When an achievement is unlocked, an accompanying animation and sound will occur to mark the occasion. Some examples of potential achievements include: [1] “Comeback Kid”—unlocked if a player comes back from behind in the last round of a WF match to win; [2] “Streaker”—unlocked when a player gets their first bonus for a scoring streak; [3] “Brainiac”—unlocked when a player gets all questions correct in any match type; [4] 100k—unlocked when a player hits a cumulative score of 100,000; [5] 500k—unlocked when a player hits a cumulative score of 500,000. There could potentially be over 50 unique achievements with more added to the app over time.

Social Networking

Users who register through the client game application will have the ability to send a Buddy request, form a list of Buddies, and invite Buddies to WF matches. In addition these players will show up on each other's Friends or Buddies leaderboard. Similarly, users who register / log in with a social networking account will have similar abilities including: Ability to see which social networking friends are also players. Ability to invite social networking friends to WF matches. View leaderboards of their friends. The client game application should also allow users to post scores and achievements they earn to a social networking profile. Note: To support any posting of progress to social networking sites, a client game application on the social networking sites will likely be needed.

Online Store, In-App Purchases, Game Currency

While playing the trivia-game, players will earn tokens as they reach certain milestones based on score totals for rounds, matches and cumulative scores. Within the client game application users will be able to redeem their tokens or purchase (via in-client game application purchase) additional tokens. With this dynamic, certain additional content will be “free” if earned but the user must spend tokens to unlock it. For example, the basic client game application that users will download from an application store does not include “Game of the Week” mode. This feature must be unlocked by spending their tokens within the online store. To unlock content within the app, a user would be required to do the following: [1] Play With Friends (WF) mode and reach 100,000 or more points to earn 10 tokens; [2] Player then can view the “Online Store” in the Account portion of the client game application; [3] In the store the user sees the following items for purchase: 10 Tokens=$0.99 via In-App Purchase. 50 Tokens=$4.00 via In-App Purchase. Premium Power-up Packs=10 tokens each (this pack includes 1 of each premium power-up). Game of the Week Mode=10 tokens (this purchase unlocks “GOTW” Mode permanently).

Application Themes (i.e., Skins)

In some implementations, a theme or “skin” for the client game application would consist of colors, a banner sized spot for a graphic, fonts and a background graphic in order to support customization of a Live event. Event administrators would be able to specify each component from a series of choices, color values, etc. and also be able to upload logos or graphics to add unique personalization to their event.

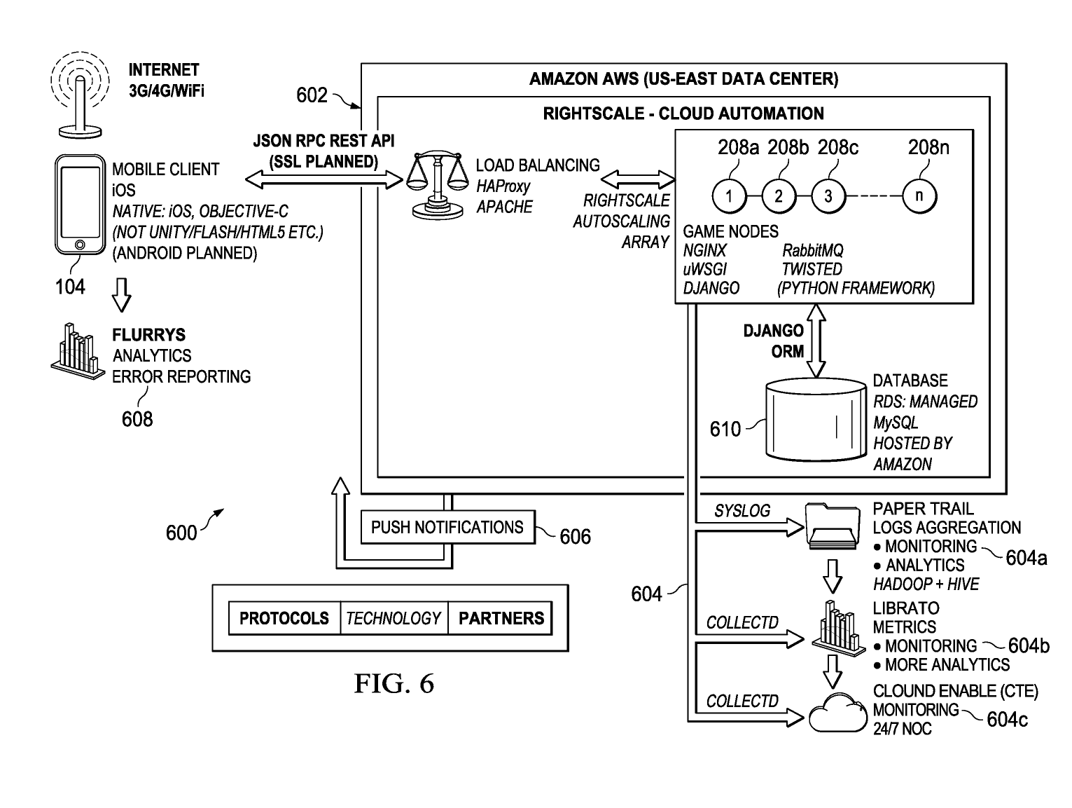

Turning now to FIG. 6, FIG. 6 is a block diagram illustrating an example framework 600 for providing system log aggregation (including monitoring and analytics), metrics gathering (including monitoring and analytics), and/or continuous system monitoring in a massively multiplayer online game (MMOG) system 602 in accordance with some implementations of the present disclosure.

FIG. 6 also illustrates infrastructure 604 added to the server-side of the MMOG system 602 to provide, among other things, metrics gathering, analytics, monitoring, and/or notification functions. For example, MMOG system 602 logs may be gathered, processed, and/or stored using one or more system log aggregators 604a. The aggregated logs may be used for monitoring (real-time, near real-time, or asynchronous) of the overall health of the MMOG system 602 and to perform analytical functions using the aggregated logs to generate analytical data associated with the operation of the MMOG system 602. MMOG system 602 data may be gathered and/or generated using one or more metrics engines 604b. The one or more metrics engines 604b may also provide functionality to monitor (real-time, near real-time, or asynchronous) the overall health of the MMOG system 602 and to generate additional analytical data associated with the operation of the MMOG system 602. Cloud-computing enabled applications, data centers, and/or operations centers 604c may further provide monitoring (real-time, near-real time, or asynchronous) of the overall health of the MMOG system 602 and a 24/7 network operations center to address system issues, update software, collect customer feedback and error reports, notify MMOG system 602 personnel of critical system issues, and other suitable tasks.

FIG. 6 also illustrates the addition of push notifications 606 to the server-side of the MMOG system 602. Push-notifications may be sent from the MMOG system 602 to mobile clients 106 and are further discussed below with respect to FIG. 2.

FIG. 6 also illustrates the addition of analytics/error reporting 606 received from the mobile client device 104. For example, the analytics/error reporting 608 may be provided by FLURRY or other suitable application executing on the mobile client device 104.

In some implementations, one or more components/services of the infrastructure 604 may be provided by 3rd-parties either local to or remote from the MMOG system 602. For example, 3rd-party cloud-computing services can be provided by remote cloud-computing service providers such as AMAZON, GOOGLE, CLOUD ENABLE, and/or other suitable cloud-computing service provider, etc. As another example, log aggregation services can be provided by hardware/software solutions either local to or remote from the MMOG system 602.

In some implementations, database 610 functionality and/or services can be provided by 3rd-party database providers. For example, database functionality and/or services may be provided by AMAZON or other suitable database provider.

Although FIG. 6 illustrates and discusses specific software/service providers, products, protocols, programs, packages, framework, and/or solutions, those skilled in the art will appreciate that this is one possible implementation of a multitude of possible implementations that could use other suitable software/service providers, products, protocols, programs, packages, framework, and/or solutions to accomplish similar desired functionality. This disclose anticipates other possible implementations not inconsistent with this disclosure for efficiency, cost, maintenance, and/or or other suitable reasons.

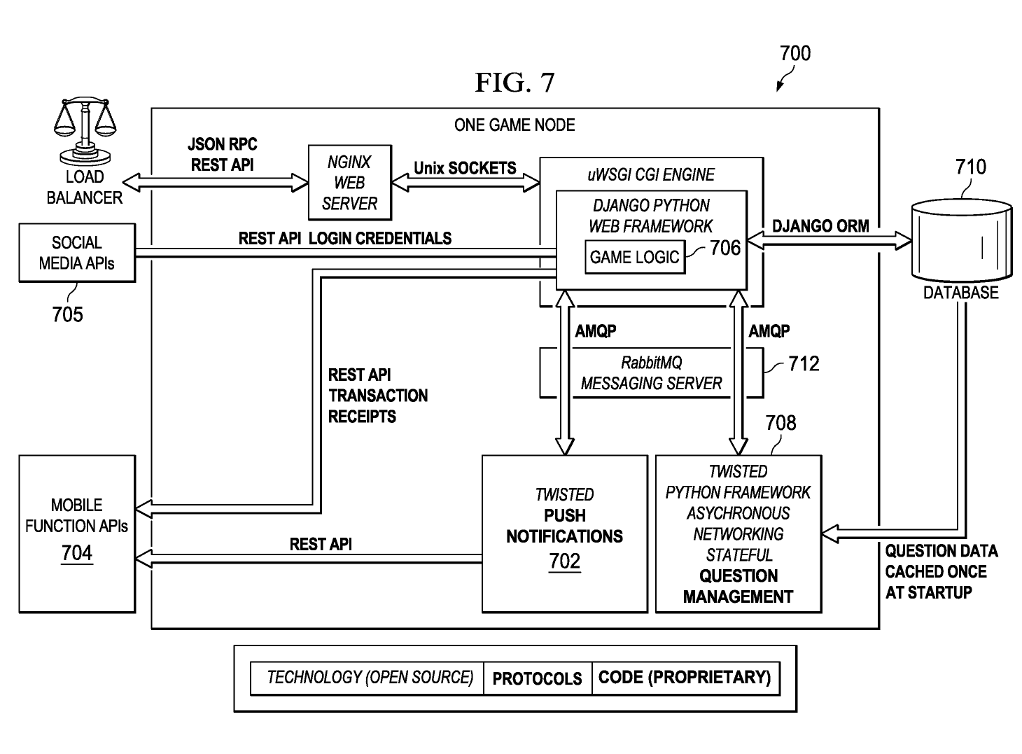

Turning now to FIG. 7, FIG. 7 is a block diagram illustrating functionality extensions to an example game node 700 in accordance with some implementations of the present disclosure. The functionality extensions provide for performance enhancements, push notifications, highly-scalable messaging, transaction verification/receipts, and/or question management functionality.

A push notification engine 702 is an event-driven networking engine providing push notification events and/or other data to mobile function provider application programming interfaces (APIs) 704 and/or game logic 706. The mobile function provider APIs 704 may provide commonly understood and/or proprietary push notification services for products running APPLE IOS, GOOGLE ANDROID, and/or other suitable push notification capable operating systems, hardware, and/or applications. In some implementations, the mobile function provider APIs 704 can also provide verification of in-application micro transactions, transaction receipts, access to application stores, send/receive status data between the game logic 706 and the mobile function provider APIs 704. In some implementations, the push notification engine can be implemented using TWISTED and/or other suitable commercial/proprietary event-driven network engines.

The game logic 706 has associated logic to interface with various social media APIs 705, for example FACEBOOK, TWITTER, and the like. As illustrated, the trivia game logic 706 can also trigger push notifications by sending requests to the push notification engine 702. In some implementations, the game logic 706 may be implemented using a DJANGO/PYTHON Web framework and/or other suitable commercial/proprietary Web frameworks.

The question management engine 708 interfaces with the database 710 to retrieve, store, update, and/or cache trivia game questions and/or associated data stored on the database 710. In some implementations, the question management engine 708 can be implemented using TWISTED and/or other suitable commercial/proprietary event-driven network engines. In some implementations, at startup, the question management engine 708 can cache all or a subset of available trivia game questions stored on the database 710 to minimize and/or eliminate the need to communicate with the database 710. In some instances, the question management engine 708 can receive messages from one or more components of the MMOG system instructing it to clear and/or update its cached trivia game questions.

The question management engine 708 also provides stateful trivia game question selection functionality. For example, the question management engine 708 understands for a particular asynchronous, turn-based, trivia game which questions have already been asked within a particular trivia game and may choose to not ask those questions again within the scope of the particular trivia game or possibly a certain number of following trivia games. As another example, the question management engine 708 may select and provide questions based on criteria including a dynamic theme selection, difficulty level, time constraints, question topic/category (either MMOG and/or player selected), mobile device type executing a MMOG client application, and/or other suitable criteria consistent with the scope of this disclosure.

In some implementations of the MMOG gameplay, the questions management engine 708 provides trivia game question selection functionality for the game logic 706. The game logic 706 requests trivia game questions from the question management engine 708. Each player is allowed to select one or more trivia game question categories and, based upon some type of contest (an ad hoc provided trivia question, randomly generated “toss” or numerical value, etc.), payment (for example tokens, actual money, etc.), and the like, questions are selected from the pool of available trivia game questions by the question management engine 708 and presented to the players according to the player-chosen categories by the game logic 706. In some implementations, the trivia game questions are presented to each of the two players in an alternative series of rounds (for example a first, second, third etc.) with a final round category also selected as previously described (contest, payment, etc.). The category of the first round, second round, etc. may be decided by the winner of the contest, payment, etc. Each of the two players is asked the same trivia game questions as the other player in the course of the particular trivia game. In other implementations, as will be appreciated by those skilled in the art, similar functionality could be adapted for a single player or more than two players. In other implementations, the MMOG system 602 could select all or some of the trivia game question categories without player input.

The messaging server 712 provides highly-scalable messaging functionality for components of the game node 700 to communicate with one or more game-node 700 internal components and/or components of the MMOG system 602 external to the game node. In some implementations, the messaging protocol used by the messaging server 712 and other game node 700 components and components of the MMOG system 602 can be native query protocol (NQP) and/or other suitable messaging protocol. In some implementations, the messaging server 712 functions can be implemented/performed in whole or in part by RABBITMQ and/or other suitable commercial/proprietary messaging systems.

Although FIG. 7 illustrates and discusses specific software/service providers, products, protocols, programs, packages, framework, and/or solutions, those skilled in the art will appreciate that this is one possible implementation of a multitude of possible implementations that could use other suitable software/service providers, products, protocols, programs, packages, framework, and/or solutions to accomplish similar desired functionality. This disclose anticipates other possible implementations not inconsistent with this disclosure for efficiency, cost, maintenance, and/or or other suitable reasons.

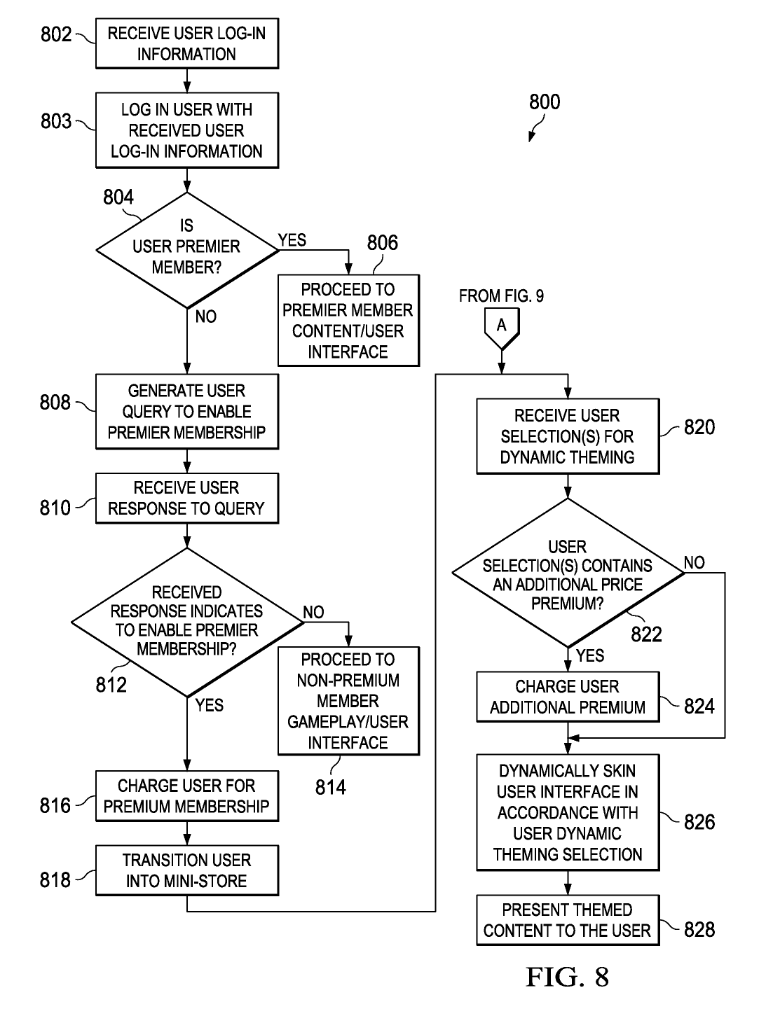

Turning now to FIG. 8, FIG. 8 is a flow chart 800 for selecting a premium membership and providing dynamic themed content and a themed user interface in a MMOG system in accordance with some implementations of the present disclosure. Method 800 may be performed by any other suitable system, environment, software, and hardware, or a combination of systems, environments, software, and hardware as appropriate. In some implementations, the method 800 may be wholly or partially substituted for method 900 (described below). In some implementations, elements of both method 800 and method 900 may be combined and/or rearranged in a manner consistent with this disclosure in order to provide access to premium content in the MMOG environment.

At 802, user log-in information is received from a MMOG client application. For example, the user log-in information may include a user id, password, numerical value, email address, and/or other suitable information for a user log-in. From 802, method 800 proceeds to 803.

At 803, the user is authenticated using the received log-in information and logged in to the MMOG system using the received user log-in information. From 803, method 800 proceeds to 804

At 804, a determination is made whether the user is a premier member. If at 804, it is determined that the user is a premier member, method 800 proceeds to 806. If at 804, however, it is determined that the user is not a premier member, method 800 proceeds to 808.

At 806, the user proceeds to premier member content using a premier member user interface. After 806, method 800 stops.

At 808, a user query is generated by MMOG system and/or the MMOG client application to request that the user enable a premier membership. From 808, method 800 proceeds to 810.

At 810, a user response is received from the MMOG client application responsive to the generated user query. From 810, method 800 proceeds to 812.

At 812, a determination is made whether the user response indicates the user wishes to enable a premium membership. If at 812, it is determined that the user wishes to enable a premier membership, method 800 proceeds to 816. If at 812, however, it is determined that the user does not wish to enable a premium membership, method 800 proceeds to 814.

At 814, the MMOG gameplay proceeds to non-premium member content using a non-premium member user interface. After 814, method 800 stops.

At 816, the user is charged for a premium membership. From 816, method 800 proceeds to 818.

At 818, the user is transitioned into a “mini-store” to allow the user to select a dynamic theme for the MMOG client application user interface. A dynamic theme may be, for example, sports team logos and colors, a music group logo, a genre theme such as science fiction, Steampunk, Victorian, etc. and other suitable genre themes, and/or a “look-and-feel” associated with a miscellaneous groups, associations, societies, clubs, organizations, etc. In some implementations, from within the MMOG client application, a user can be presented a list(s) of available dynamic theme options that are selectable from within the MMOG client application. From 818, method 800 proceeds to 820.

At 820, a user selection for a dynamic theme is received from the MMOG client application. In some implementations, the user can be allowed to forego the selection of a theme and remain with a default user-interface configuration. The default user interface configuration may be the same or different as compared to a non-premium member user interface configuration. In some implementations, the selection of the dynamic theme may be made at a later time and/or “cancelled” to revert back to the default theme. In other implementations, a premium member may switch between various dynamic themes. In some implementations, an additional fee may be charged to switch dynamic themes. From 820, method 800 proceeds to 822.

At 822, a determination is made whether the selected dynamic theme contains an additional price premium. If at 822, it is determined that the selected dynamic theme contains an additional price premium, method 800 proceeds to 824. If at 822, however, it is determined that the selected dynamic theme does not contain an additional price premium, method 800 proceeds to 826.

At 824, the user is charged an additional premium. In some implementations, an additional query may be presented to the user to allow the user to either accept or refuse the additional price premium. From 824, method 800 proceeds to 826.

At 826, the user's client application user interface is dynamically “skinned” in accordance with the user's dynamic theme selection. In some implementations, a theme or “skin” for the client application user interface can consist of colors, graphics, fonts, sounds, or other suitable user interface elements to provide a specific theme. In order to support dynamic themed customization, system administrators would also be able to specify each component from a series of choices, color values, etc. and also be able to upload logos or graphics to add unique personalization for their event that would be selectable by a player as a dynamic theme. From 826, method 800 proceeds to 828.

At 828, themed content is presented to the user. In some implementations, the specific theme can modify a default presentation method/format in order to present the specific theme/themed content. Themed content may include content specifically associated with the selected dynamic theme, associated dynamic themes, and/or non-themed content. After 828, method 800 stops.

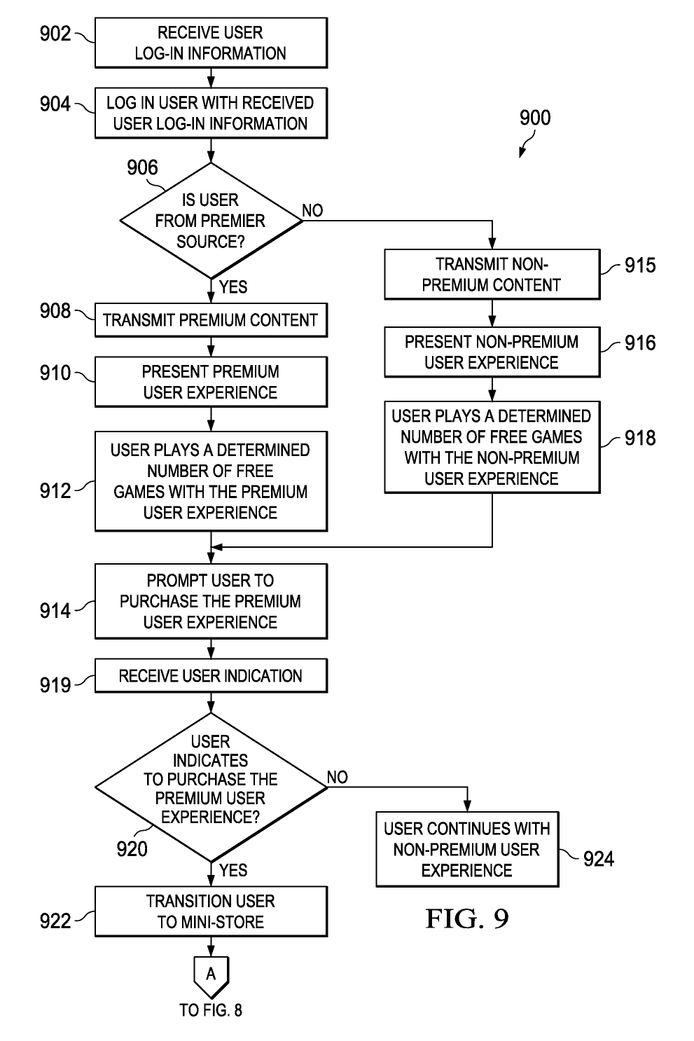

Turning now to FIG. 9, FIG. 9 is a flow chart 900 for selecting premium content in a MMOG system in accordance with some implementations of the present disclosure. Method 900 may be performed by any other suitable system, environment, software, and hardware, or a combination of systems, environments, software, and hardware as appropriate. In some implementations, the method 900 may be wholly or partially substituted for method 800 (described above). In some implementations, elements of both method 900 and method 800 may be combined and/or rearranged in a manner consistent with this disclosure in order to provide access to premium content in the MMOG environment.

At 902, user log-in information is received from a MMOG client application user interface. For example, the user log-in information may include a user id, password, numerical value, email address, and/or other suitable information for a user log-in. From 902, method 900 proceeds to 904.

At 904, the user is authenticated by the MMOG system using the received log-in information and logged in to the MMOG system using the received user log-in information. From 904, method 900 proceeds to 906

At 906, a determination is made whether a user is from a premier source. A premier source may be how the user discovered the MMOG including, for example, an association to the MMOG provided by a celebrity, a particular hyperlink (e.g., a hyperlink purchased from the MMOG to be considered “premier”), an organization, a political event, a sporting event, and the like. For example, if a user discovered the MMOG and/or client application in an application store or by selecting a link on a particularly popular celebrity's social media posting, such as a posting on TWITTER or FACEBOOK, the MMOG can determine that these are the reasons why the user created an account with the MMOG and whether the reasons indicate a “premier” source. In some implementations, reason data indicating a premier source can be stored, dynamically generated, downloaded, etc. In some implementations, reason data can be based on a predetermined value (e.g., popularity factor, etc.), location, user profile, income, interests, demographics, type of game, date, time, etc. If at 906, it is determined that the user is from a premier source, method 900 proceeds to 908. If at 906, however, it is determined that the user is not from a premier source, method 900 proceeds to 915.

At 908, premium content is transmitted to the user's device, such as using the Internet and/or other network. Is some implementations, the user may be prompted to access some or all of the premium content from a specific location in lieu of receiving transmitted premium content, web/network site, etc. From 908, method 900 proceeds to 910.

At 910, a premium user experience introduction and premium content is presented on the user's device and the user is presented with a premium user experience. For example, the premium user experience may display some or all of the premium content, enhance gameplay, simplify gameplay, add additional features and functionality, and/or other suitable premium/non-premium content, themes, functionality, and the like. From 910, method 900 proceeds to 912.

At 912, the user is allowed to play a determined number of games with the premium user experience prior to prompting to purchase the transmitted and/or additional premium content. In some implementations, the determination can be made on the user's device and/or the MMOG system. In some implementations, the determination can be made dynamically by an algorithm and/or based on a predetermined value. Data used by an algorithm may include location, user profile, income, interest, demographics, type of game, date, time, whether a potential game opponent has premium content, and/or other suitable data. For example, the number of games a user may be allowed to play before being prompted to select to purchase the premium user experience may be set to a predetermined value of one or dynamically generated based on one or more of the above-identified data values. In another example, a user with non-premium user experience wishing to play a game with a user with a premium user experience can result in a prompt to the non-premium experience user to purchase a premium user experience to permit the game with the premium experience user to proceed. From 912, method 900 proceeds to 914.

At 914, the user is prompted to purchase the premium user experience. After 914, method 900 proceeds to 919.

At 919, a user indication is received whether to purchase the premium user experience. From 919, method 900 proceeds to 920.

At 915, non-premium content is transmitted to the user's device, such as using the Internet and/or other network. Is some implementations, the user may be prompted to access some or all of the non-premium content from a specific location in lieu of receiving transmitted premium content, web/network site, etc. From 915, method 900 proceeds to 916.

At 916, a non-premium user experience introduction and non-premium content is displayed on the user's device and the user is presented with a non-premium user experience. From 916, method 900 proceeds to 918.

At 918, the user is allowed to play a determined number of non-premium games prior to prompting to purchase premium content. In some implementations, the determination can be similar to the determination described at 912. From 918, method 900 proceeds to 914.

At 920, a determination is made whether the user response indicates the user wishes to purchase the premium user experience. If at 920, it is determined that the user wishes to purchase the premium user experience, method 900 proceeds to 922. If at 920, however, it is determined that the user does not wish to purchase the premium user experience, method 900 proceeds to 924 where the user continues with a non-premium user experience. After 924, method 900 stops.

At 922, the user is transitioned into a “mini-store” to allow the user to select and purchase the premium user experience for the MMOG client application user interface. Premium user experience options can include additional features, information, cheats, hints, power-ups, and the like. Premium content included with the premium user experience can include, for example, sports team logos and colors, a music group logo, a genre theme such as science fiction, Steampunk, Victorian, etc. and other suitable content, and/or a “look-and-feel” associated with a miscellaneous groups, associations, societies, clubs, organizations, and the like. In some implementations, from within the MMOG client application, a user can be presented a list(s) of available premium user experience and/or premium content options that are selectable from within the MMOG client application. From 922, method 900 proceeds to perform steps similar to 820-828 as described in FIG. 8 with respect to selection of and payment for the premium user experience and/or premium content. In other implementations, other suitable steps consistent with this disclosure for the selection and payment of the premium user experience and/or premium content can be performed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program include, by way of example, can be based on general or special purpose microprocessors or both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method, comprising:
authenticating a user for access to an asynchronous, turn-based, massively-multiplayer online game (MMOG) with user account log-in information received from a client computing apparatus following direction to the MMOG from a MMOG source;
determining that the MMOG source is classified as premier;
transmitting premium content associated with the MMOG source to the client computing apparatus;
prompting to purchase a premium user experience;
receiving an indication to purchase the premium user experience; and
transitioning to a mini-store to permit purchase of the premium user experience.

2. The method of claim 1, wherein the MMOG source is at least one of a demographic value, a date, a time, a location, an organization, a political event, a sporting event, a hyperlink, or a social media posting.

3. The method of claim 1, wherein a premium user experience is presented on the client computing apparatus using the transmitted premium content.

4. The method of claim 3, wherein the premium user experience includes at least one of enhanced gameplay, additional gameplay functionality, additional premium content, or themes.

5. The method of claim 3, further comprising playing a determined number of free games with the premium user experience.

6. The method of claim 1, further comprising determining that an indication was received to purchase the premium user experience.

7. The method of claim 1, further comprising:
transmitting non-premium content to the client computing apparatus;
presenting a non-premium user experience using the transmitted non-premium content; and
playing a determined number of free games with the non-premium user experience.

8. A non-transitory, computer-readable medium storing computer-readable instructions executable by a data processing apparatus and configured to:
authenticate a user for access to an asynchronous, turn-based, massively-multiplayer online game (MMOG) with user account log-in information received from a client computing apparatus following direction to the MMOG from a MMOG source;
determine that the MMOG source is classified as premier;
transmit premium content associated with the MMOG source to the client computing apparatus;
prompt to purchase a premium user experience;
receive an indication to purchase the premium user experience; and
transition to a mini-store to permit purchase of the premium user experience.

9. The medium of claim 8, wherein the MMOG source is at least one of a demographic value, a date, a time, a location, an organization, a political event, a sporting event, a hyperlink, or a social media posting.

10. The medium of claim 8, wherein a premium user experience is presented on the client computing apparatus using the transmitted premium content.

11. The medium of claim 10, wherein the premium user experience includes at least one of enhanced gameplay, additional gameplay functionality, additional premium content, or themes.

12. The medium of claim 10, further storing instructions to play a determined number of free games with the premium user experience.

13. The medium of claim 8, further storing instructions to determine that an indication was received to purchase the premium user experience.

14. The medium of claim 8, further storing instructions to:
transmit non-premium content to the client computing apparatus;
present a non-premium user experience using the transmitted non-premium content; and
play a determined number of free games with the non-premium user experience.

15. A computer system, comprising:
at least one computer configured to:
authenticate a user for access to an asynchronous, turn-based, massively-multiplayer online game (MMOG) with user account log-in information received from a client computing apparatus following direction to the MMOG from a MMOG source;
determine that the MMOG source is classified as premier;
transmit premium content associated with the MMOG source to the client computing apparatus;
prompt to purchase a premium user experience;
receive an indication to purchase the premium user experience; and
transition to a mini-store to permit purchase of the premium user experience.

16. The system of claim 15, wherein the MMOG source is at least one of a demographic value, a date, a time, a location, an organization, a political event, a sporting event, a hyperlink, or a social media posting.

17. The system of claim 15, wherein a premium user experience is presented on the client computing apparatus using the transmitted premium content.

18. The system of claim 17, wherein the premium user experience includes at least one of enhanced gameplay, additional gameplay functionality, additional premium content, or themes.

19. The system of claim 17, further configured to play a determined number of free games with the premium user experience.

20. The system of claim 15, further configured to determine that an indication was received to purchase the premium user experience.

21. The system of claim 15, further configured to:
transmit non-premium content to the client computing apparatus;
present a non-premium user experience using the transmitted non-premium content; and
play a determined number of free games with the non-premium user experience.
